(19) United States
(12) Patent Application Publication
(10) Pub. No.: US 2014/0173660 A1
(43) Pub. Date: Jun. 19, 2014

(54) SYSTEM AND METHOD FOR DISTRIBUTING AND MANAGING MULTIPLE CONTENT FEEDS AND SUPPLEMENTAL CONTENT BY CONTENT PROVIDER USING AN ON-SCREEN LITERACTIVE INTERFACE

(71) Applicant: WHISPER INNOVATIONS, LLC, Greenville, SC (US)

(72) Inventors: Jeffrey Curtis Correa, Johns Creek, GA (US); Goran Osim, Myrtle Beach, SC (US); Jonathan R. Spear, Stone Mountain, GA (US); Steven Matthew Cox, Charleston, SC (US)

(73) Assignee: WHISPER INNOVATIONS, LLC, Greenville, SC (US)

(21) Appl. No.: 14/184,462

(22) Filed: Feb. 19, 2014

Related U.S. Application Data
(63) Continuation of application No. PCT/US2012/066130, filed on Nov. 20, 2012.
(60) Provisional application No. 61/678,255, filed on Aug. 1, 2012.

(51) Int. Cl. H04N 21/2665; H04N 21/262; H04N 21/258; H04N 21/2668; H04N 21/81

(52) U.S. Cl. CPC H04N 21/2665; H04N 21/2668; H04N 21/812; H04N 21/25866; H04N 21/26283; H04N 21/8173
USPC 725/42

(57) ABSTRACT

A system for system administrator to distribute and manage multiple content feeds and supplemental content using an on-screen interactive interface includes: (a) various multimedia sources configured to provide multiple content feeds and supplemental contents, (b) a multimedia server configured to integrate multiple content feeds and supplemental contents over a network, (c) a computer communicatively coupled to the network configured for the system administrator to manage the schedule and the source of the multimedia sources, and (d) a multimedia control platform for various viewers to manage, access, and select the multiple content feeds and supplemental contents from the multimedia server through an on-screen interactive interface, and to display selected contents in various end user devices. The multiple content feeds and supplemental contents include one or more of following contents: (a) real time broadcast contents, (b) multimedia streaming contents, (c) supplemental multimedia contents, (d) multimedia content management information, and (e) advertisement contents.

### CROSS-REFERENCE TO RELATED APPLICATIONS

This application claims priority of a PCT International Application no. PCT/US2012/066130 filed Nov. 20, 2012, entitled “System and Method for Providing and Managing Multiple Content Feeds and Supplemental Content by Information Provider Using an On-Screen Interactive Interface”, by Jeffrey Correa, Goran Osim, Jonathan Spear, Patrick Foard, and Steven Cox, the disclosures for which is hereby incorporated herein in their entireties by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to distributing broadcast and streaming content and its related information to viewers, and more particularly to a system and method for content providers to distribute and manage multiple content feeds and supplemental content by using an on-screen interactive interface.

### BACKGROUND OF THE INVENTION

The background description provided herein is for the purpose of generally presenting the context of the present invention. Work of the presently named inventors, to the extent it is described in this background section, as well as aspects of the description that may not otherwise qualify as prior art at the time of filing, are neither expressly nor impliedly admitted as prior art against the present invention.

Today people live in an information age and receive information constantly from many different sources, such as, radio, over-air or cable broadcast television, newspapers, and websites on the internet. Information from radio is broadcasted over radio networks. Information from television is broadcasted over cable or over air, and received on television set. Information from websites is received over computers, tablets, and/or smartphones. It is desirable to have one device that utilizes information from radio, broadcast television, stream videos, IPTV as well as websites.

On the other hand, due to the popularity of Digital Video Recorder (DVR), many people watch their favorite content at their own time instead of watching them according to the TV broadcasters' schedule. One of the advantages of watching TV program on DVR is that viewers can skip commercials advertisements inserted in the TV program. Although this is beneficial to the viewers, it is not beneficial to commercial advertisers. An interactive platform to relate commercial advertisements to the viewers in an interesting way is needed to keep the viewers interested in the programs they are watching and the commercials that relate to the TV programs.

For advertisers, there is also a need to have a central platform that users are interested to receive information constantly, and for the advertisers to have a medium to display relevant advertisements according to the contents a user requested and displayed so that advertisements are more relevant and effective to the viewers.

Therefore, heretofore unaddressed needs exist in the art to address the aforementioned deficiencies and inadequacies.

### SUMMARY OF THE INVENTION

In one aspect, the present invention relates to a system for a system administrator to distribute and manage multiple content feeds and supplemental content using an on-screen interactive interface. In certain embodiments, the system includes one or more of: (a) various multimedia sources configured to provide multiple content feeds and supplemental contents, (b) a multimedia server configured to integrate multiple content feeds and supplemental contents over a network, (c) a computer communicatively coupled to the network configured for the system administrator to manage the schedule and the source of various multimedia sources, and (d) a multimedia control platform for viewers to manage, access, and select the multiple content feeds and supplemental contents from the multimedia server through an on-screen interactive interface and to display selected contents in various end user devices. In one embodiment, the multiple content feeds and supplemental contents includes one or more of following contents: (a) real time broadcast contents, (b) multimedia streaming contents, (c) supplemental multimedia contents, (d) multimedia content management information, and (e) advertisement contents.

In certain embodiments, the multimedia control platform includes a multimedia API, and the multimedia API is configured to allow end user devices to access the multiple content feeds and supplemental contents. In one embodiment, the multimedia control platform is embedded in the end user devices. In another embodiment, the multimedia control platform is embedded in a multimedia controller.

In certain embodiments, the multimedia server includes one or more of: (a) an admin web server configured to allow the system administrator to distribute and manage the multiple content feeds and supplemental contents, and (b) a multimedia database configured to store all system configuration information, the schedules of the multiple content feeds and supplemental contents, links to multimedia contents and streaming contents.

In certain embodiments, the on-screen interactive interface has one or more of following areas: (a) a content selection area for the system administrator to select current content, (b) a menu bar area configured to provide the system administrator various options to distribute and manage multiple content feeds and supplemental content, (c) a title area configured to display the title of the current content selected by the system administrator, and (d) a main display area configured to display information related to the current content and the specific option the system administrator selected. The location and the size of the content selection area, the menu bar area, the title area, and the main display area can be setup by the system administrator through a menu option setting.

In certain embodiments, the menu bar area has one or more of following options: (a) a Dashboard option to provide the system administrator an overview of the current content, (b) a Campaigns option to allow the system administrator to set up various campaigns related to the current content, (c) an applications option to allow the system administrator to set up various applications related to the current content, (d) a streams option to allow the system administrator to set up various streams related to the current content, (e) a social network option to allow the system administrator to set up various social network access available to the current content, (f) an earnings option to display the system administrator the earning information related to the current content, (g) a users option to display the system administrator the statistics of user interactions, (h) a reports option configured to allow the system administrator to generate various reports related to the current content, (i) an ADS option configured to allow the system administrator to set up various advertisements related to the current content, and (j) a settings option configured to allow the system administrator to set up the system administrator's preferences.

In another aspect, the present invention relates to a method for a system administrator to distribute and manage multiple content feeds and supplemental content using an on-screen interactive interface. In certain embodiments, the method includes one or more of following operations: (a) logging into a computer communicatively coupled to a network, (b) accessing a multimedia server configured to integrate multiple content feeds and supplemental contents over the network, and the multiple content feeds and supplemental contents are received from various multimedia sources, (c) managing operations and sources of the multiple content feeds and supplemental contents, and (d) providing the schedules and sources of the multiple content feeds and supplemental contents to a multimedia control platform for various viewers to manage, access, select, and display the selected contents from the multimedia server to selected various end user devices.

In one embodiment, the multiple content feeds and supplemental contents may include one or more of these content sources: (a) real time broadcast contents, (b) multimedia streaming contents, (c) supplemental multimedia contents, (d) multimedia content management information, and (e) advertisement contents. The multimedia control platform includes a multimedia API configured to allow the end user devices to access the multiple content feeds and supplemental contents. In one embodiment, the multimedia control platform is embedded in an end user device. In another embodiment, the multimedia control platform is embedded in a multimedia controller.

In one embodiment, the on-screen interactive interface includes one or more of following areas: (a) a content selection area for the system administrator to select current content, (b) a menu bar area configured to provide the system administrator various options to select, (c) a title area configured to display the title of the current content selected by the system administrator, and (d) a main display area configured to display information related to the current content and the specific option the system administrator selected. In one embodiment, the menu bar area includes one or more of following options: (a) a Dashboard option to provide the system administrator an overview of the current content, (b) a Campaigns option to allow the system administrator to set up various campaigns related to the current content, (c) an applications option to allow the system administrator to set up various applications related to the current content, (d) a streams option to allow the system administrator to set up various streams related to the current content, (e) a social network option to allow the system administrator to set up various social network access available to the current content, (f) an earnings option to display the system administrator the earning information related to the current content, (g) a users option to display the system administrator the statistics of user interactions, (h) a reports option configured to allow the system administrator to generate various reports related to the current content, (i) an ADS option configured to allow the system administrator to set up various advertisements related to the current content, and (j) a settings option configured to allow the system administrator to set up the system administrator's preferences.

In yet another aspect, the present invention relates to a non-transitory storage medium having computer-executable instructions stored on it. When the computer-executable instructions are executed by one or more processors of a system to distribute and manage multiple content feeds and supplemental content using an on-screen interactive interface, the computer-executable instructions cause the system to perform one or more of following operations: (a) logging into a computer communicatively coupled to a network, (b) accessing a multimedia server configured to integrate multiple content feeds and supplemental contents over the network, and the multiple content feeds and supplemental contents are received from various multimedia sources, (c) managing operations and sources of the multiple content feeds and supplemental contents, and (d) providing the schedules and sources of the multiple content feeds and supplemental contents to a multimedia control platform for various viewers to manage, access, select, and display the selected contents from the multimedia server to selected various end user devices. In certain embodiments, the multiple content feeds and supplemental contents include one or more of following contents: (a) real time broadcast contents, (b) multimedia streaming contents, (c) supplemental multimedia contents, (d) multimedia content management information, and (e) advertisement contents.

In certain embodiments, the multimedia control platform has a multimedia API. The multimedia API is configured to allow various end user devices to access the multiple content feeds and supplemental contents. In one embodiment, the multimedia control platform is embedded in the end user devices. In another embodiment, the multimedia control platform is embedded in a multimedia controller. In certain embodiments, the on-screen interactive interface contains one or more of following areas: (a) a content selection area for the system administrator to select current content, (b) a menu bar area configured to provide the system administrator various options to select, (c) a title area configured to display the title of the current content selected by the system administrator, and (d) a main display area configured to display information related to the current content and the specific option the system administrator selected.

In one embodiment, the menu bar area includes one or more of following options: (a) a Dashboard option to provide the system administrator an overview of the current content, (b) a Campaigns option to allow the system administrator to set up various campaigns related to the current content, (c) an applications option to allow the system administrator to set up various applications related to the current content, (d) a streams option to allow the system administrator to set up various streams related to the current content, (e) a social network option to allow the system administrator to set up various social network access available to the current content, (f) an earnings option to display the system administrator the earning information related to the current content, (g) a users option to display the system administrator the statistics of user interactions, (h) a reports option configured to allow the system administrator to generate various reports related to the current content, (i) an ADS option configured to allow the system administrator to set up various advertisements related to the current content, and (j) a settings option configured to allow the system administrator to set up the system administrator's preferences.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the invention, and wherein:

FIG. 1 is a block diagram of a system for Managing and Accessing multiple content feeds and supplemental content using an on-screen interactive interface according to one embodiment of the present invention;

FIG. 2 shows an exemplary on-screen interactive interface of a multimedia platform video player for Managing and Accessing multiple content feeds and supplemental content using the on-screen interactive interface according to one embodiment of the present invention;

FIG. 3 shows an exemplary on-screen transparent interactive content grid on top of streaming content display for displaying various designs of interactive icons and images according to one embodiment of the present invention;

FIG. 4 shows an exemplary icon displays on the on-screen transparent interactive content grid on top of the multimedia platform video player according to one embodiment of the present invention;

FIG. 5 is a flow chart illustrating the collection, storage and transmission of streaming content from content provider to end users according to one embodiment of the present invention;

FIG. 6 is a flow chart illustrating the collection, storage and transmission of video contents and management information contents according to one embodiment of the present invention;

FIG. 7 shows an exemplary Gantt chart display of an operational schedule inside the multimedia platform for Managing and Accessing multiple content feeds and supplemental content using an on-screen interactive interface according to one embodiment of the present invention;

FIG. 8 is a flow chart illustrating how a viewer interacts with vendors within the multimedia platform according to one embodiment of the present invention;

FIG. 9 is a flow chart illustrating how the multimedia server generates network report based on the viewer interaction with the multimedia server and platform according to one embodiment of the present invention;

FIG. 10 is a flow chart illustrating how various multimedia sources provide streaming contents to a multimedia server and platform according to one embodiment of the present invention;

FIG. 11 is a flow chart illustrating how various end user devices receive streaming contents through a multimedia API according to one embodiment of the present invention;

FIG. 12 shows Dashboard Settings of an exemplary interactive interface for content providers of a system for providing and managing multiple content feeds and supplemental content using an on-screen interactive interface according to one embodiment of the present invention;

FIG. 13 shows Campaign Settings of the exemplary interactive interface according to one embodiment of the present invention;

FIG. 14 shows Applications Settings of the exemplary interactive interface according to one embodiment of the present invention;

FIG. 15 shows Streams Settings of the exemplary interactive interface according to one embodiment of the present invention;

FIG. 16 shows Social Settings of the exemplary interactive interface according to one embodiment of the present invention;

FIG. 17 shows Earnings Settings of the exemplary interactive interface according to one embodiment of the present invention;

FIG. 18 shows Users Settings of the exemplary interactive interface according to one embodiment of the present invention;

FIG. 19 shows Reports Settings of the exemplary interactive interface according to one embodiment of the present invention;

FIG. 20 shows Ads Settings of the exemplary interactive interface according to one embodiment of the present invention;

FIG. 21 shows the System Settings of the exemplary interactive interface according to one embodiment of the present invention; and

FIG. 22 shows the contents and management information managed through an interactive interface of a multi-function device according to certain embodiments of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to. The terms “viewer” and “user” are to be understood as interchangeable. Both terms “videos” and “information” (text and other forms of data) are types of content; hereafter the term content can refer to either video, text, or any other type of data able to be uploaded to a multimedia platform. Additionally, the term multi-function device refers to any device that has a processor and display components contained within itself. For example, all smartphones, tablet computers, iPods, and screened mobile devices are multi-function devices because they can execute software code through their processor and display the interpreted information on their device screen.

Prior to a detailed description of the present invention, the following definitions are provided as an aid to understanding the subject matter and terminology of aspects of the present invention, and not necessarily limiting of the present invention, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

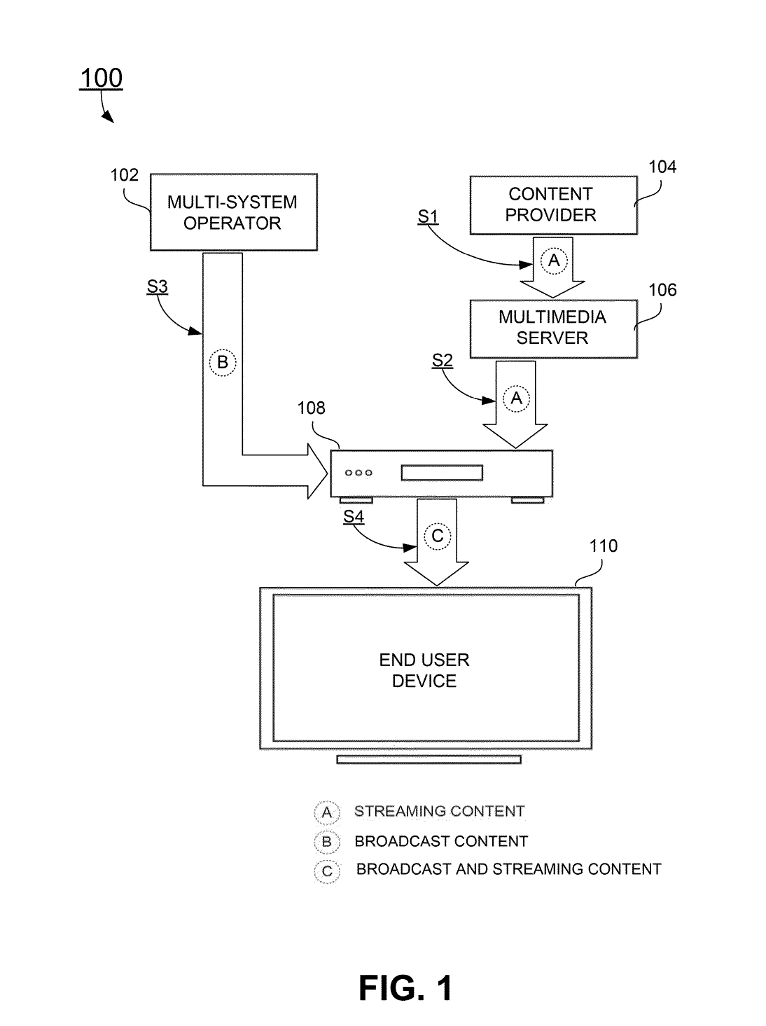

The description will be made as to the embodiments of the present invention in conjunction with the accompanying drawings in FIGS. 1-22. The description will be made in two general areas: (1) an on-screen interactive interface for a viewer to manage and access multiple content feeds and supplemental contents, and (2) an interactive interface for a system administrator of multimedia sources to distribute and manage multiple content feeds and supplemental contents.

A. An On-Screen Interactive Interface for a Viewer to Manage and Access Multiple Content Feeds and Supplemental Contents

In accordance with the purposes of this invention, as embodied and broadly described herein, this invention, in one aspect, related to a system 100 for Managing and Accessing multiple content feeds and supplemental content using an on-screen interactive interface. In one embodiment, system 100 includes one or more of following components: (a) a multimedia server 106 configured to integrate streaming contents from various streaming content providers through a streaming contents provider 104, (b) a multimedia controller 108 configured to receive broadcast contents from various multi-system operators 102, and the streaming contents from the multimedia server 106, and (c) a multimedia control platform 602 for a viewer 10 (not shown in FIG. 1) to manage, select and access the broadcast contents and the streaming contents through an on-screen interactive interface, and to display the selected contents on an end user device 110.

As shown in FIG. 1, the streaming contents are received from the content provider 104 in process S1, and then transmitted to the multimedia controller 108 through the multimedia server 106, in process S2. The broadcast contents are received from the multi-system operators 102 directly and transmitted to the multimedia controller 108, in process S3. The broadcast contents and streaming contents are combined at the multimedia controller 108 and then transmitted to the end user device 110 for display in process S4 as shown in FIG. 1.

In another aspect, the present invention relates to a method for Managing and Accessing multiple content feeds and supplemental content using an on-screen interactive interface. In one embodiment, the method includes one or more of following operations:
(a) collecting, consolidating and tagging streaming contents from a content provider 104 and making the streaming contents available to a viewer 10 through a multimedia server 106 and a multimedia controller 108;
(b) retrieving broadcast contents and the schedule of the broadcast content through a multimedia controller 108 and making the broadcast contents and its schedule available to the viewer 10 through a multimedia control platform 602;
(c) allowing the viewer 10 to manage and access the broadcast contents and streaming contents by the viewer 10 through an on-screen interactive interface of the multimedia control platform 602, and schedule the broadcast contents and streaming contents to be displayed to the viewer 10 according to the schedule of the broadcast contents and the streaming contents and viewer's selection; and
(d) displaying the broadcast contents or the streaming contents the viewer selected to an end user device 110.

In one embodiment, the multimedia controller 108 has one or more of: (a) an internet connection for receiving integrated streaming contents from the multimedia server 106, and (b) an output to the end user device for displaying the viewer selected contents (can be internal output to device monitor), (c) a cable input for receiving broadcast contents through various cable television providers, (d) an over-air input for receiving broadcast contents through various of direct broadcast television providers, and (e) an output to the end user device 110 for displaying the viewer selected contents. The cable input and over-air input may be (a) a coaxial cable input, (2) a RF input, and (3) a High-Definition Multimedia Interface (HDMI) input. The internet connection may be (1) a direct wired connection to an internet service provider, or (2) a Wi-Fi network connected to an internet service provider. The output to the end user device 110 includes one or more of: (1) a component video output, (2) a composite video output, (3) an S-video output, (4) an HDMI output, (5) a coaxial cable output, (6) a Bluetooth interface, (7) a Wi-Fi interface, and (8) a wireless communication interface.

The end user device 110 includes at least one of: (a) a television set 110-1, (b) a desk top or laptop computer 110-2, (c) a smartphone 110-3, (d) a tablet computer 110-4, . . . , and (e) a multi-function device 110-N.

In one embodiment, a firmware portion of the system 100, a multimedia control platform is embedded in the multimedia controller 108. In another embodiment, the multimedia control platform is embedded in the end user device 110. The multimedia control platform includes an on-screen interactive interface.

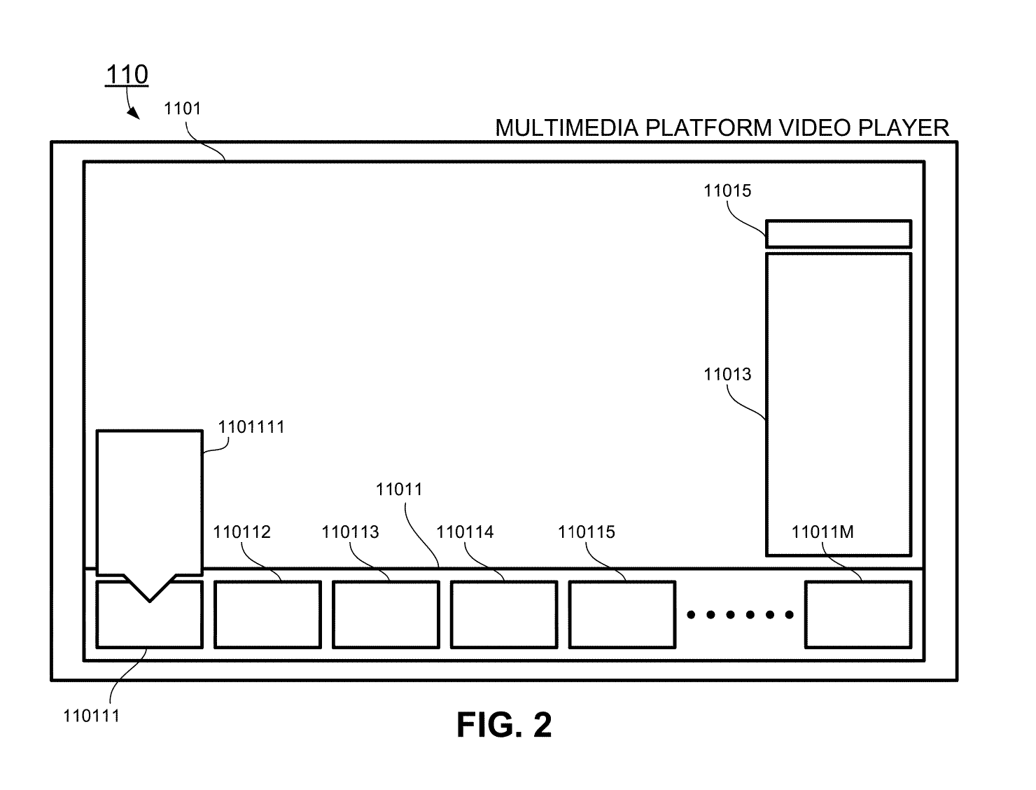

Referring now to FIG. 2, an exemplary on-screen interactive interface of the multimedia platform video player 100 for managing and accessing multiple content feeds and supplemental content is shown according to one embodiment of the present invention.

In one embodiment in which a television screen 1101 is used as an example of TV set 110. The on-screen interactive interface is configured to have one or more of following elements:
(a) an Interactive Bar 11011 at a preset location of display area 1101 of the end user device 110. In one embodiment, the Interactive Bar 11011 is located at a bottom of the display area of the end user device 110. According to the user's preference, the location of the Interactive Bar 11011 can be set at either left side, right side of the display area 1101, or the top of the display area, or indeed anywhere of the display area that is desirable by the viewer 10. In one embodiment, the Interactive Bar 11011 has various application icons 110111, 110112, 110113, 110114, 110115, . . . , and 11011M for the viewer 10 to navigate and select the broadcast contents and streaming contents. Each of the plurality of application icons 110111, 110112, 110113, 110114, 110115, . . . , and 11011M itself can be configured to have a multi-layer menu. For example, when the application icon 110111 is selected by the viewer 10 by using the remote control, a multi-layer menu 1101111 is popped up and presenting options for the viewer 10 to review and select if the viewer 10 desires to do so.
(b) a notification icon 11013 for displaying information to the viewer 10 without being prompted;
(c) an on-screen space 11015 for the viewer 10 to retrieve and/or display information regarding a piece of content without leaving current display screen; and
(d) a scheduler to schedule all broadcast content and streaming content displays according to the broadcast systems' schedule and the viewer's selection.

During the normal television viewing, the Interactive Bar may be hidden, and not shown in the screen. When the viewer 10 presses the screen of a touchscreen device, an option on a remote control, or a keyboard of the end user device 110, the Interactive Bar may be shown to allow viewer interaction. After a predetermine time of no interaction by the viewer 10, the Interactive Bar may be faded away for a better viewing of the contents displayed on the screen.

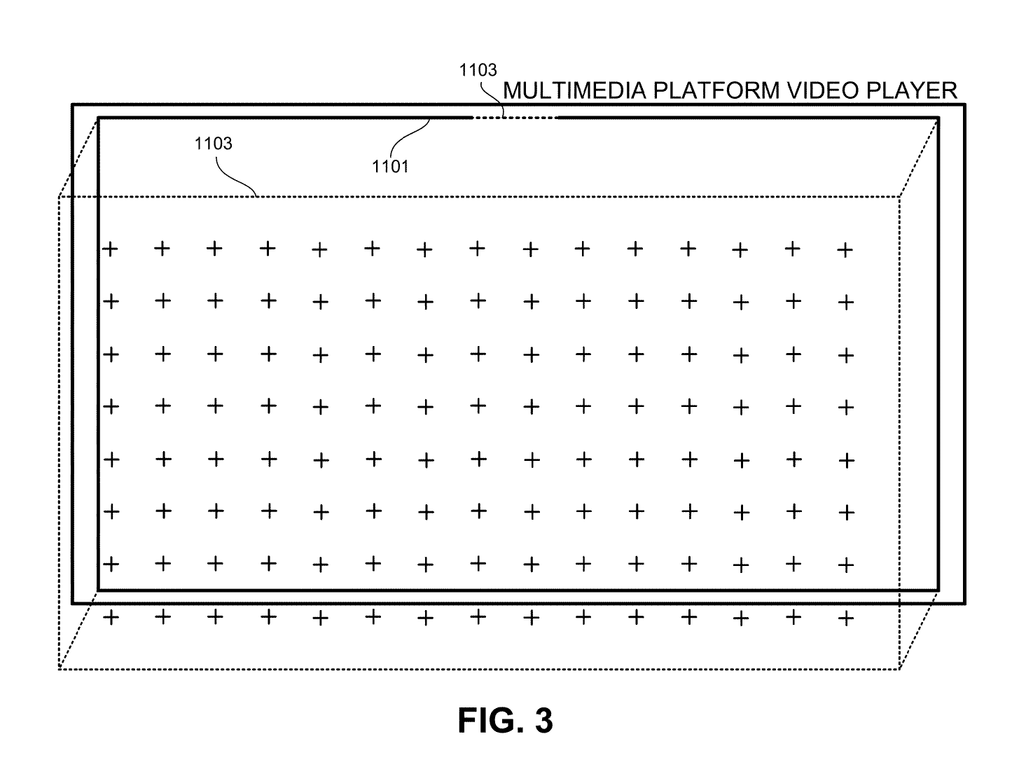

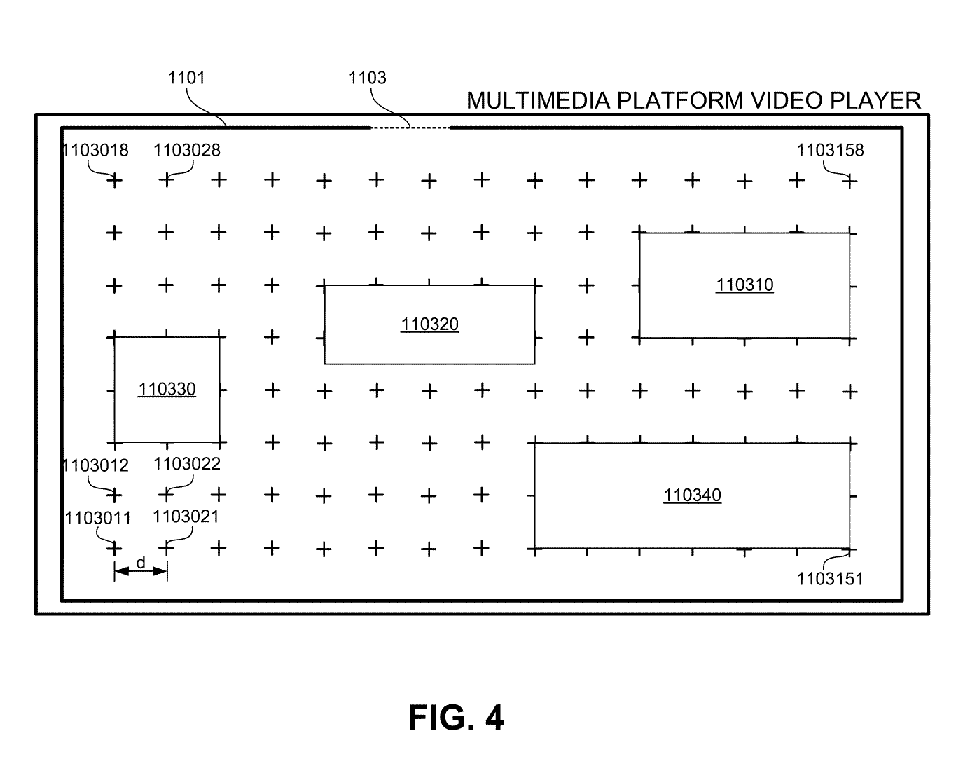

Referring now to FIGS. 3 and 4, an exemplary on-screen transparent interactive content grid 1103 is shown on top of streaming content display area of a multimedia platform video player 1101 according to one embodiment of the present invention. In one embodiment, the broadcast contents, the streaming contents, the management information contents, and advertisement contents are managed and accessed by the viewer 10 through this on-screen transparent interactive content grid 1103 of the on-screen interactive interface. The transparent content grid includes a grid determined by screen dimension information that is stored based on the viewer's input. In the example shown in FIG. 4, an aspect ratio of 9:16 wide screen is used. The on-screen transparent interactive content grid 1103 is divided equally into 9 sections vertically, and 16 sections horizontally, and the intersection point of these sections are marked with a “+”. The intersection point “+” at the lower left corner is marked as 1103011, the intersection point “+” at the top left corner is marked as 1103018, the intersection point “+” at the lower right corner is marked as 1103151, and the intersection point “+” at the top right corner is marked as 1103158. The distance between two neighboring intersection points is d. Horizontally, the intersection points from the left to the right are 1103011, 1103021, 1103031, . . . , and 1103151. Vertically, the intersection points from the bottom to the top are 1103011, 1103-012, 1103013, . . . , and 1103018. For a traditional screen with an aspect ratio of 3:4, the grid can be divided similarly.

The on-screen transparent interactive content grid 1103 allows the viewer 10 to arrange various display areas such as 110310, 110320, 110330, and 110340. These display areas are used to display some or all of following:
(a) various application icons 110111, 110112, 110113, 110114, 110115, . . . , and 11011M, each having a menu for displaying available options for viewer 10 to select, wherein these application icons can be rearranged, placed, created, deleted and managed by the viewer 10 according to user's settings;
(b) a notification icon 11013 for displaying information to the viewer 10 without being prompted;
(c) an on-screen space 11011 for the viewer 10 to retrieve and/or display information regarding a piece of content without leaving current display screen;
(d) a viewer preference icon for the viewer 10 to setup the arrangement of contents, applications, option links, notifications, viewer profile management and parental controls;
(e) various optional links that are linked to some optional link applications; and
(f) a video table for viewer's easy access to the contents available to the viewer 10.

In one embodiment, each of the display areas 110310, 110320, 110330, and 110340 are arranged by giving the coordinates of the lower left corner, the height, and the width of the display area. The size of the display area is determined by the specific information to be displayed. These display areas 110310, 110320, 110330, and 110340 are proportional to the screen aspect ratio.

In one embodiment, the application icons 110111, 110112, 110113, 110114, 110115, . . . , and 11011M include one or more of:
(a) Current Content: an option to change the current piece of content being viewed, displays content name, logo etc;
(b) Information: about the content on the screen, including title, subtitle, a representative picture, and time remaining etc;
(c) My Settings: including a submenu for accounts settings, a submenu for Interactive Bar settings, and a submenu for launching sample commercials;
(d) Shop: launching shopping application directly related to the commercials showing on the screen;
(e) Music Video: music videos related to the current content on the screen, or main character in the current content;
(f) Gateways: for travel related contents, certain favorite travel destinations can be included as advertisement;
(g) Trivia: including trivia about the current content on the screens;
(h) Extra: a few snippets of the current content such as behind the screen segments etc;
(i) Recipes: if the current content is food related, the viewer 10 can select this application icon to view the related recipes, the ingredients list and where to purchase them etc;
(j) Episodes: a few recent episodes may be listed, both most recent shown and commercial about upcoming episodes;
(k) What's Hot: a few latest hot contents from the same or related content;
(l) Vote: viewers can use this icon to vote whether the current content is good, or not so good, which character is the best or worst; and
(m) Contents: other contents offered by the same or related content.

These icons can be fully customized and arranged by the viewer 10 to fit his/her need through the application My Settings. The Account Setting may include some or all of the viewer 10's name, address, income bracket, education level, ethnicity, viewer/screen name, age group, My Save directory settings, credit card information for purchasing merchandises showing on the screen by simply clicking an option, etc. The Interactive Bar submenu may include viewer's preferences for applications icons to be included, arranged and accessed. The Commercial submenu may include the recent commercial aired so the viewer 10 can catch up some missed commercials.

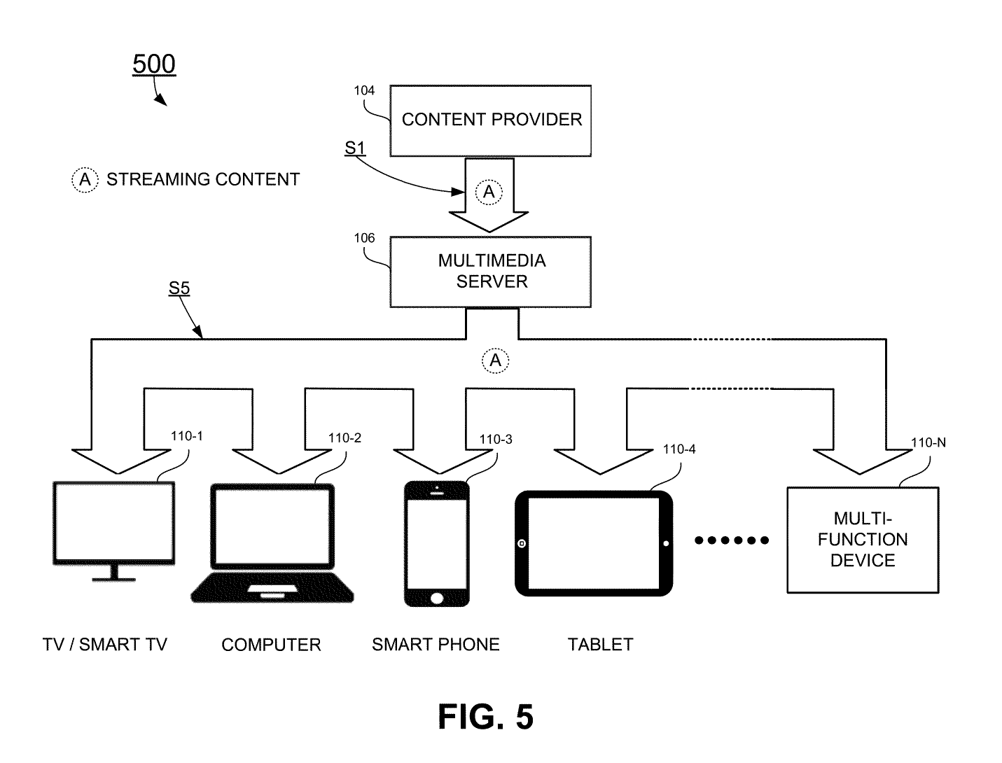

Referring now to FIG. 5, a flow chart 500 illustrating the collection, storage and transmission of streaming content is shown according to one embodiment of the present invention. Certain streaming contents are sourced from the content provider 104. It will be appreciated to people skilled in the art that certain contents that are streamed from the content provider 104 include contents from a variety of sources such as the Internet and IPTV. These contents are made available for the viewer 10 to review and select. The viewer 10 selected contents are received and stored in the multimedia server 106 in streaming content format in process S1. The streaming contents are further transmitted to at least one of the end user devices such as a TV 110-1, a desktop or a laptop computer 110-2, a smartphone or mobile phone 110-3, an iPad or other tablet computer 110-4, . . . , or any other multi-function device 110-N in process S5. In this embodiment, a multimedia control platform in the form of a firmware is embedded in the end user device 110, and information transmission in process S5 between the multimedia server 106 and the end user devices 110 is through internet either via a direct internet connection or a Wi-Fi network.

In one embodiment, streaming content provider 104 delivers certain contents, which may include contents containing certain advertising information from advertisers that advertise on the content provider 104 along with its airing time to multimedia server 106, or provide multimedia server 106 with a link that will take the viewer 10 directly to content hosted by the content provider or advertiser themselves, foregoing the need to store the content on the multimedia server 106. Once the content or link and its respective airing times are received by multimedia server 106, it is then made available to be streamed by all devices. Any devices that are in communication with multimedia server 106 and compatible with the corresponding multimedia control platform, such as interactive TVs, computers, smartphones, tablets, and any other multi-function device will be able to receive any streaming content from the multimedia server 106. The received streaming contents can be displayed for current use or stored for later use. For example, the viewer 10 may log into his/her account on his/her tablet and looking up items in a corresponding “my saves” directory, which stores the received streaming contents to get more information or purchase one or more items. Because all the information is stored on multimedia server 106 and streamed upon request, no content will be stored on any end user devices, only the multimedia control platform software will be on the end user devices, which does not occupy valuable memory space and thus negatively impact the performance of the end user devices.

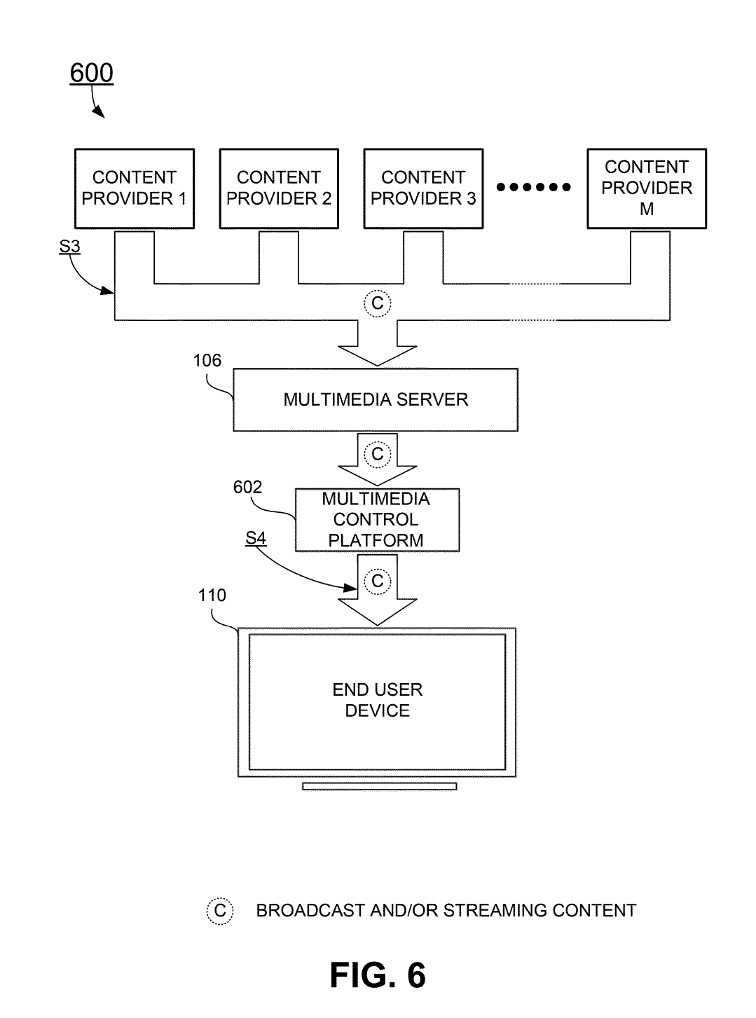

Referring now to FIG. 6, a flow chart illustrating the collection, storage and transmission of streaming contents is shown according to one embodiment of the present invention. The streaming contents are received in a digital format as marked B from various direct content providers Content Provider 1, Content Provider 2, Content Provider 3, . . . , and Content Provider m, in process S3. These contents are made available for viewer 10 to select at the multimedia control platform 602, or for future streaming, the operational schedule of these streaming contents are stored in the multimedia control platform 602. The viewer 10 selected contents or the operational schedule of the contents are stored in the multimedia server 106. The streaming contents are then transmitted to the multimedia control platform 602. The streaming contents are further transmitted to the end user devices 110, such as an interactive TV, computer, smartphone or mobile phone, tablet computer, or any other multi-function devices connected to the multimedia platform.

In one embodiment, the content providers Content Provider 1, Content Provider 2, Content Provider 3, . . . , and Content Provider m, collect, consolidate, and tag their content that they wish to make available for viewers through the multimedia control platform 602, and the Content Provider data is received into the multimedia server 106 and stored for use. The multimedia control platform 602 is loaded with provider contents via streaming data and set to become available during given periods of time, which are set up in a multimedia server backend system which controls what content the viewer 10 sees at any given time. Finally the end user device 110 receives the information form the multimedia control platform 602 and displays it on its monitor, making it available for viewer's interaction.

In one embodiment, the broadcast contents and streaming contents further include advertisements from various advertisers with the advertisement links stored in the multimedia control platform 602 to allow a viewer 10 to access the advertisement content through the links without storing the actual advertisement content in the multimedia server 106. The viewer's interactions with the advertisements can be recorded. The advertisements are provided to the multimedia server 106 either randomly or related to the viewer preferences and the broadcast contents and the streaming contents the viewer selected. The streaming contents and advertisement contents are collected, consolidated and tagged by the content provider 104, and made available to the viewer 10 through the multimedia server 106 and the multimedia control platform 602.

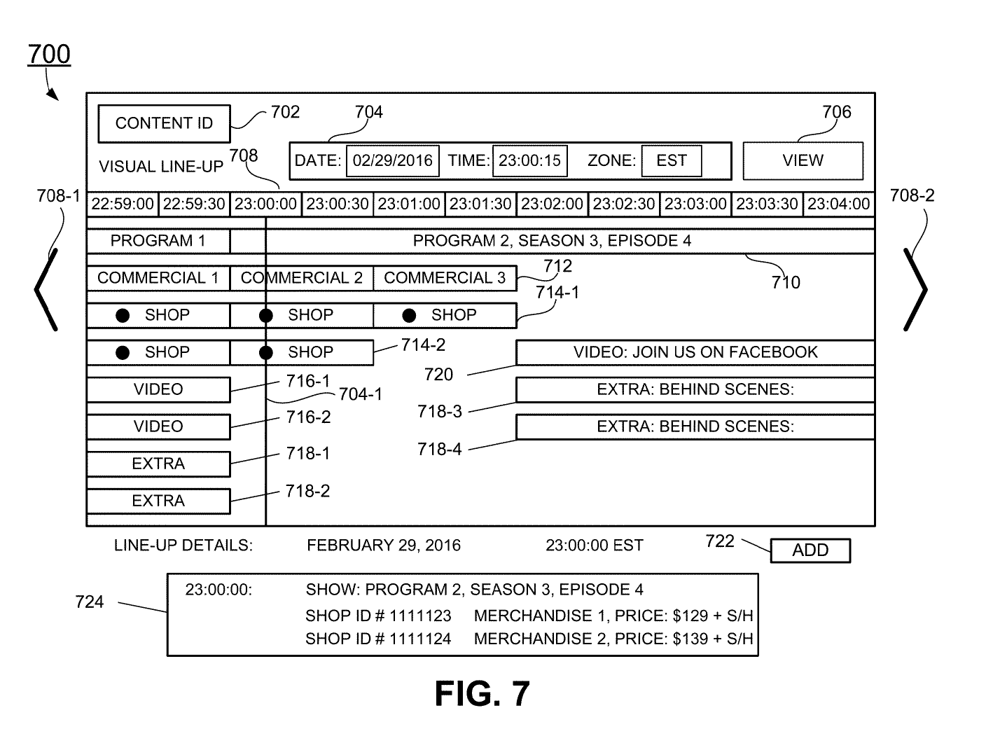

An exemplary Gantt style schedule 700 is shown in FIG. 7 to illustrate the schedule discussed above according to one embodiment of the present invention. The schedule 700 is set by an administrator of the stream contents provider. The schedule shown in FIG. 7 is for one piece of content only. The schedule includes one or more of:
(a) a content identification 702: to display the current content name, logo, and an option to change the current piece of content either by entering a different content id number, or by locating it in the list of content contained on the platform;
(b) a time bar 704: to display the current date, the current time, and the current the time zone setting, with a vertical line 704-1 to display the precise time on the schedule;
(c) a view option 706: to preview/live view the content currently being managed;
(d) a schedule time mark 708: to display the schedule in 30 seconds increment with a left arrow 708-1 to navigate to an earlier time segment, or a right arrow 708-2 to navigate to a later time segment.
(e) a content title bar 710: to display the title of contents on the schedule in their respective time slots;
(f) an advertisement bar 712: to display various advertisements scheduled to broadcast in their respective time slots;
(g) a shop bar 714 with sub-segments 714-1, 714-2: to indicate various merchandises shown the commercial on the screen are available for the Shop application in their respective time slots;
(h) a stream bar 716 with sub-segment 716-1 and 716-2: to allow the content to display related videos, streams, advertisements etc;
(i) an Extra bar 718 with sub-segment 718-1, 718-2, 718-3, and 718-4: to allow the content to display extra contents related to the contents, behind the scene extra contents;
(j) a Facebook link 720: to make the Facebook link available to the application to allow the viewer 10 to quickly and conveniently link to Facebook;
(k) an ADD option 722: to allow the system administrator to add/edit/delete the content schedule; and
(l) a current content lineup detail 724: to describe the details about the content, its related commercials, and information about the related merchandises available for purchase during the content display.

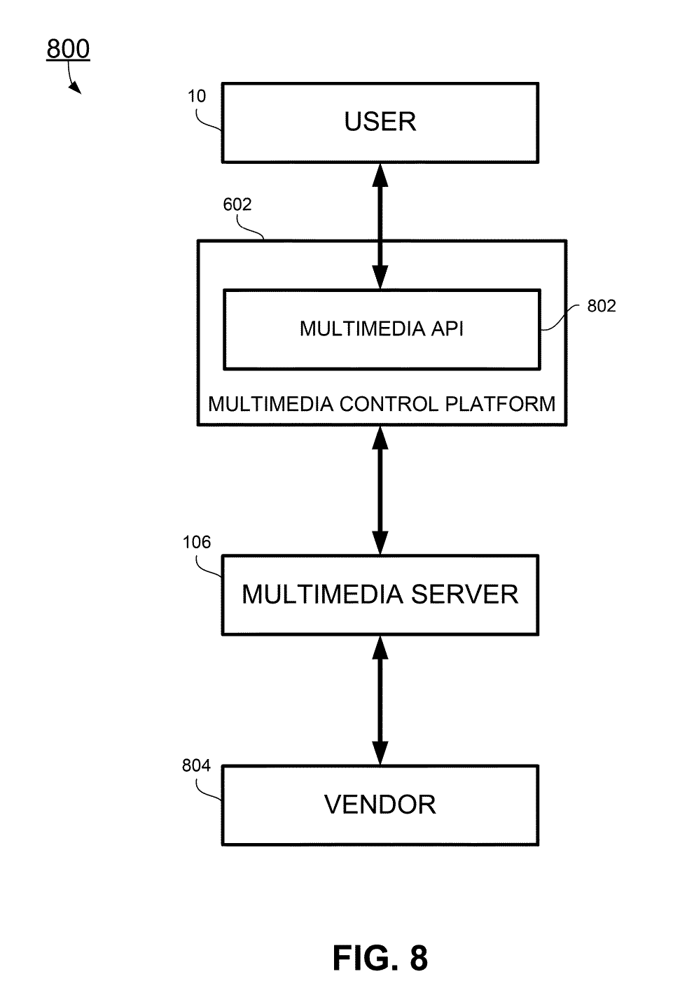

Referring now to FIG. 8, a flow chart illustrating how the viewer 10 interacts with vendors is shown according to one embodiment of the present invention. The viewer 10 interacts with the vendor through a Multimedia API 802 of a Multimedia Control Platform 602 and a Multimedia Server 106. The viewer 10 views and selects certain products as shown on the screen to retrieve the product information/advertisement provided by a vendor 804. The advertisement and product/purchase information can be retrieved by accessing the multimedia server 106 if the information is stored in the multimedia server 106, or allocated dynamically through links to the vendor's database.

In one embodiment, the viewer 10 uses a remote control of a TV, a keyboard for a computer, or a touch screen interface for a multi-function device (smartphone) to navigate on the screen, selects certain information to view details, and initiates a purchase through the Multimedia API 802 of the Multimedia Control Platform 602 embedded in an end user device. The Multimedia Server 106 will forward purchase information to the vendor 804, including the purchaser's name, shipping address, contact information of the viewer 10 such as email address for emails and phone number for texting, product information such as shop ID, number of unit purchased, unit price, and any specific request or shipping instructions from the viewer 10. The vendor 804 receives the purchasing information from multimedia server 106 and begins preparing the viewer's order. The vendor 804 is responsible for fulfillment of the order from this point. The vendor 804 may send acknowledgement back to the viewer 10 through the Multimedia Server 106, the Multimedia Control Platform 602, and the Multimedia API 802. The acknowledgement may also be sent to the viewer 10 via email. On the other hand, this purchase is also recorded in the Multimedia Server 106, along with information about the purchaser (viewer 10) as part of statistics of the shopping activities associated with the ad campaign.

It is noted that although in one or more embodiments described above that one or more notification icons can be used to make purchases, such as with the “Buy It Now” function or “Shop Now” etc.; however, one or more notification icons or notifications can be utilized for additional uses. Some can be utilized to allow the viewer 10 to access more information about a product being advertised. The viewer 10 can click the notification icon or option link and it could open up a “Floating Interactive Content Area” that is placed on the transparent grid. This is customizable in shape, size, color, and content. Viewers can insert various forms of code (like php, html, java, etc.) in these spaces to create interactive advertisements and experiences. For example, a Nissan Leaf® commercial could send a notification to a viewer to “learn more” which opens up the “Floating Interactive Content Area” allowing the viewer 10 to view more information on the vehicle and even play a game. These spaces are for all types of interactive content including news articles, RSS feeds, advertisements, games, alternative content, and more.

In one embodiment, the on-screen interactive interface is configured to allow the viewer 10 to interact through a touch screen means of an option pushing means of a remote control or a keyboard of an interactive television set 110-1, a multi-function device 110-N, a computer 110-2, a smartphone 110-3, or a tablet computer 110-4.

In one embodiment, the on-screen interactive interface is configured to allow a viewer 10 to interact with vendors 804 of commercial products advertised to do one or more of the following:
(a) to watch a commercial displayed simultaneously with other content display;
(b) to visit a shopping center by clicking the icon for shopping center;
(c) to click any option links on an advertisement bar; and
(d) to make an on-screen purchase through floating option links on the transparent content grid.

In one embodiment, the on-screen interactive interface is configured to allow a viewer 10 to perform on-screen purchase by:
(a) clicking a floating option-link on the transparent content grid in front of streaming video and content from the providers;
(b) selecting commercial products to purchase using the on-screen interactive interface;
(c) making purchase authorization from a previously saved advertisement; and
(d) making PIN confirmation before purchase, wherein the PIN is a digital code created by a viewer 10 when the viewer account is first setup.

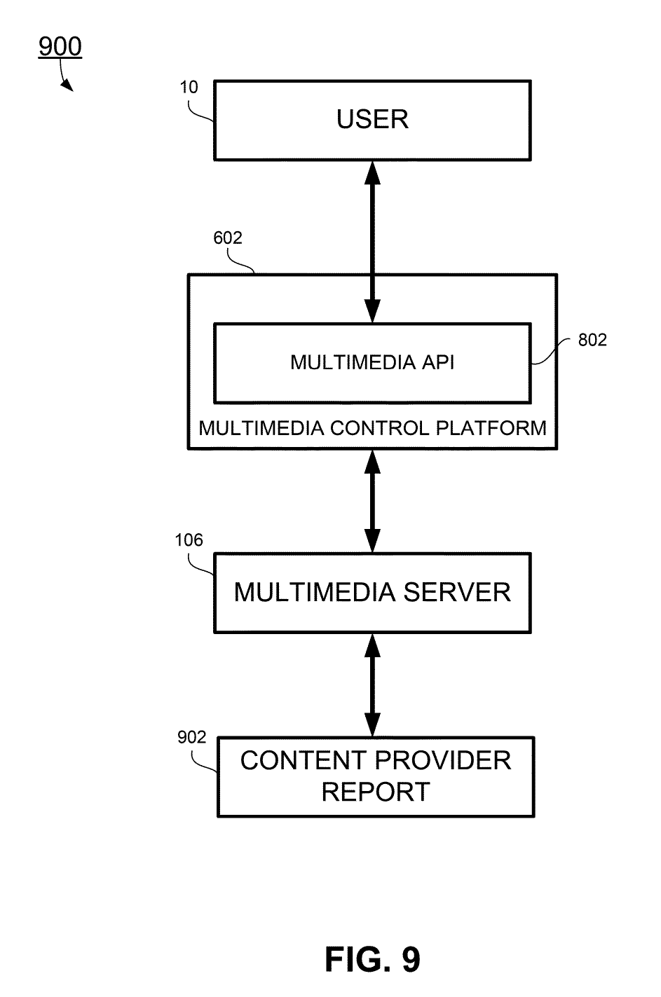

Referring now to FIG. 9, a flow chart illustrating how the Multimedia Server 106 generates a content provider report based on the viewer interaction with the Multimedia Server 106 is shown according to one embodiment of the present invention. In one embodiment, viewer 10 interacts with a Multimedia Control Platform 602 via a Multimedia API 802 and all viewer interactions are recorded to the Multimedia Server 106. Viewer data recorded includes, but is not limited to: applications opened, contents viewed, and advertisements interacted with.

In one embodiment, the multimedia server 106 uses tags of content to analyze individual viewer's interests and frequently viewed content of the same categories. For example, the system will be able to identify a viewer's interest by looking at frequently viewed content tags, such as baseball games. The system may use the tags linked to the game of the MLB, baseball, a specific baseball team, and sports to suggest future contents in these categories to the viewer 10. The system also looks at what applications or icons the viewer 10 most frequently interacts with. If the viewer 10 interacts with the shopping application on most pieces of content he/she views, the system would then showcase the shopping application content on more videos for the viewer.

After the system has analyzed the viewer's interactions for a specified period of time, the multimedia server will generate reports 902 for each piece, or groups of content, outlining tendencies and desires of viewers in each demographic. Therefore each content source can adjust their marketing strategies according to the feedbacks or reports from the customers to better target their customers and improve their advertising campaign. It should be appreciated that the reports can be generated in real-time as the ad campaign is on going, such that the advertisers can adjust their ad campaign strategy based on the feedback or the reports 902. For example, based on the reactions to a specific ad campaign in the east coast region, the advertisers can adjust their specific campaign strategy in west coast region to maximize profit margin of the ad campaign.

Following is an example of the operation of the viewer interactive interface to manage and access multiple content feeds and supplemental content according to one embodiment of the present invention.

In one embodiment, an on-screen interactive interface is embedded in a television set top box (STB). When a viewer turns on a TV along with the STB and selects a piece of content to watch, the first thing to do is to log into his/her account for content viewing and accounting purpose. The TV may have a default account, or multiple accounts such as in a shared rental home or college dormitory. Based on the viewer's settings, if there is only one account associated with this TV, then, the TV can be defaulted to automatically log into the viewer's account. If the TV is set up with multiple accounts, when the TV is turned on, then at least one of the accounts has to be log in before the any content is available to be viewed.

After the viewer is logged in, the streaming content along with an on-screen interactive interface—Interactive Bar 11011—are shown on the screen 1101 as shown in FIG. 2. The Interactive Bar 11011 can be displayed at the bottom of the screen, either sides of the screen, or on the top of the screen, depending on the viewer's preference and settings. If the viewer does not interact with the device for a predetermined time, the Interactive Bar 11011 may fade away from the screen 1101. During normal viewing of content, when the viewer interacts with the device, the interactive bar 1101 will appear on the screen 1101 again for the viewer to make selections.

In one embodiment, the Interactive Bar 11011 includes one or more applications (APP) icons. These APP icons include one or more of the following:
Content selection option: this option is used to display the currently selected piece of content including content id and video name, with its logo.
Information about the currently selected content: this portion includes the name of the currently selected content, the current date and time, the time remaining with a time remaining bar display etc. There is no controllable/selectable icon in this portion.
My settings: this icon allows the viewer to make detailed settings for the viewer's account, which may include some or all of following information:
a. My account—Account settings: the viewer's profile is entered here including the viewer's: name, address, gender, age group, ethnic group, income bracket, education level, username, password, credit card account, and any other personal information.
b. Interactive Bar—Interactive Bar settings: the settings of the Interactive Bar 11011 are entered here, including the numbers of APP icons, the types of the APP icons, the order of the APP icons, the location of the APP icons, the contents of each of the APP icons, the size of the APP icons, the locations of the APP icons etc.
c. Commercials—Launch Sample Commercials: the viewer may select this menu item to launch some sample commercials provided by the source of the current content during a specific time period. These commercials are likely related to the content.
Trivia—Random Trivia or factoids about someone, something, or some events related to the current content for the viewer to play.
Extras—A few extra snippets of the current content that were not included in the content, such as, a few scenes the main character have performed in the past, or upcoming contents, the host who appeared in other episodes of a similar show, and other anecdotes about characters in the current content etc.
Gateway—this is an APP icon related to a travel related content for the advertisers to showcase some related travel destinations along with tour packages or options for the viewer to select.
Recipes—something related to a food related content for advertisers to present the viewer the detail of the recipes, the instructions to make the food, and the ingredients list, and the links to purchase these ingredients. The recipes can be downloaded, or mail to the viewer's email account.
Chefs—this APP icon allows the viewer to watch some other contents by the same chefs as shown in the main content.
Restaurant—this APP icon display a list of restaurants that serve similar food in the viewers' areas based on the viewers' location.
Daily Deals—this APP icon displays a list of hot deals of the day.
Episodes—This APP icon allows the viewer to watch several recent episodes of the current content, or advertisements for upcoming episodes.
Sweepstake—This APP icon allows the viewer to enter into some Sweepstakes to encourage viewer participation. If the Sweepstake APP icon is selected, the participation of the viewer is communicated to a Multimedia server where all participations are collected and tallied.
What's Hot—this APP icon displays a few latest hot contents on the multimedia platform video player.
Contents—this APP icon displays a predetermined amount of hit contents offered by the currently selected piece of content.
Book/Buy Now—this APP icon allows the viewer to buy the merchandise shown on the screen or Book the travel from a list of travel agencies. A “My Save” may be provided to save certain merchandise information so the viewer can come back to make a decisions later.
Vote—this APP icon allows the viewer to vote/participate in the contest. The icon provides viewer a list of things to rate/vote, and options to cast the vote, end the vote, and cancel the vote, and an option to see the interactive voting results.
The viewer uses the remote control, a keyboard, or a touch screen to control the options, and APP icons on the screen 1101. Here are a few examples of viewer's actions:
   a. the viewer presses the Content selection option to display currently selected content including content id and video name, with its logo, and a content up and a content down options to allow the viewer to change content.
   b. the viewer may also change the content by pressing the content up option, the content down option, or the number option to change content on the remote control.
   c. it may also include a pause option to allow the viewer to temporarily pause the content display, if the display device and the content permit such operation.
   d. content selection option may also include an option for the TV to display the TV schedule of all contents where the viewer can use the up and down option to browse the TV guide page by page.
When the viewer select the “My settings” APP icon, the viewer will be able to set up his/her account. For each device, there can be one account setup for an entire family, or several account setups for a residence such as a dormitory with several people. When there is only one account setup, a login screen may be skipped. For a multiple account device, a login screen will be presented when the device is turned on. This icon allows the viewer to make detailed settings for the viewer's account, which may include some or all of following information:
   My account—Account settings: the viewer's profile is entered here including the viewer's: name, address, gender, age group, ethnic group, income bracket, education level, username, password, credit card account, and any other personal information.
   Interactive Bar—Interactive Bar settings: the settings of the Interactive Bar 11011 are entered here, including the numbers of APP icons, the types of the APP icons, the order of the APP icons, the location of the APP icons, the contents of each of the APP icons, the size of the APP icons, the locations of the APP icons etc.
   Commercials—Launch Sample Commercials: the viewer may select this menu item to launch some sample commercials provided by the source of the content during a specific time period. These commercials are likely related to the content.
When the viewer presses the “Trivia” APP icon, a preset number of random trivia or factoids about someone, something, or some events related to the current content are offered as options for the viewer to select. Also options such as “Vote”, “Select”, or “Back” will also be placed on this APP icon to allow the viewer to vote on the Interactive Bar 11011.
When the viewer presses the “Extras”—A few extra snippets of the current content that were not included in the content, such as, a few scenes the main character have performed in the past, or upcoming contents, the host who appeared in other episodes of a similar content, and other anecdotes about characters in the current content etc.
When the viewer presses the “Gateway” APP icon, a list of related travel destinations along with tour packages or options is offered for the viewer to select.
When the viewer presses the “Recipes” APP icon, a list of the related recipes, the instructions to make the food, and the ingredients list, and the links to purchase these ingredients are presented to the viewer to select. The recipes can be downloaded, or mail to the viewer's email account. The selected ingredients to be purchased can be placed in a “My Save” basket so the viewer can come back later to purchase.
When the viewer presses the “Chefs” APP icon, some other contents by the same chefs as shown in the main content.
When the view presses the “Restaurant” APP icon, a list of restaurants that serve similar food in the viewers' areas based on the viewers' location will be offered as options for the viewer to select.
When the viewer presses the “Daily Deals” APP icon, a list of hot deals of the day is offered for the viewer to select.
When the viewer presses the “Episodes”, several recent episodes of the current content or advertisements for upcoming episodes are displayed on the menu as options.
When the viewer presses the “Sweepstake” APP icon, the viewer enter into some Sweepstakes offered by the content provider to encourage viewer participation. If the Sweepstake APP icon is selected, the participant's eligibility is checked against the personal profile setup in the “My Settings” and the participation of the viewer is communicated to a Multimedia server where all participations are collected and tallied if the viewer is eligible to participate in the sweepstake.
When the viewer presses the “What's Hot” a few latest hot contents are shown as recommendations for the viewer such that the viewer is kept in the same content provider family.
When the viewer presses the “Contents” APP icon, a predetermined amount of hit contents offered by the currently selected piece of content are shown as options for the viewer to keep the viewer in the same stream.
When the viewer presses the “Book/Buy Now” APP icon, the viewer is able to make purchases of the merchandise shown on the screen or Book the travel from a list of travel agencies. A “My Save” may be provided to save certain merchandise information so the viewer can come back to make a decisions later.
When the viewer presses the “Vote” APP icon, the viewer votes in a survey, or participates a contest. The icon provides viewer a list of things to rate/vote, and options to cast the vote, end the vote, and cancel the vote, and an option to see the interactive voting results.

When the one of the APP icons display on the screen is selected and it may require a new screen to display the selected segment of related information. Then a new screen of a predetermined size appears in the predetermined location and display the selected segment, and the original main content display on the screen will be paused until the segment is finished and the new screen disappears. The new screen may have an option to make it full screen show, and another option of the full screen content display to returns to the screen of the predetermined size. When the viewer selects a “close” option on the new screen, the new screen is closed and the original main content display resumes.

These APP icons enhance the TV viewing experience, allow viewers to expand viewing contents, and provide the advertisers a targeted interactive advertisement platform such that the advertisements become more effective, and efficient.

B. An Interactive Interface for a System Administrator of Multimedia Sources to Distribute and Manage Multiple Content Feeds and Supplemental Contents

In addition, to provide a viewer to have an interactive video content viewing experience, the content provides also need to have a platform to upload and distribute live or stream contents, extras, trivia, provide a complete advertisement platform so that the advertisers can schedule and provide advertisement campaign contents to a multimedia server for the viewers, and provide a method to collect statistical data so the content providers can measure the success of advertisement campaigns.

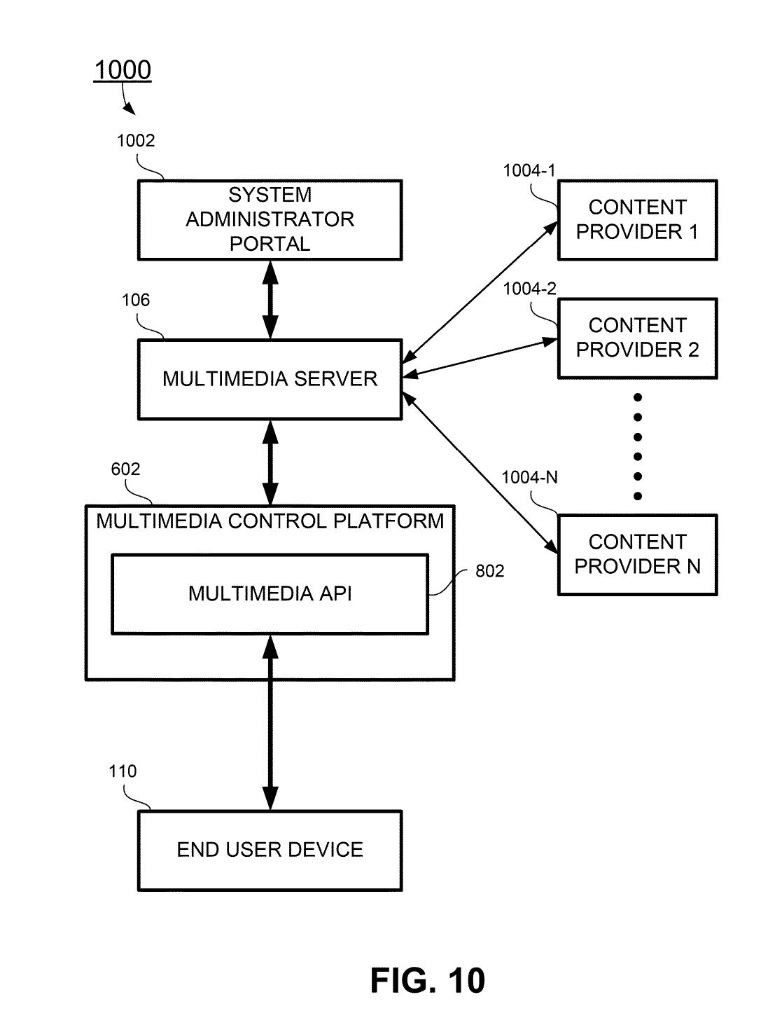

Referring now to FIG. 10, a block diagram of a system configuration of a system 1000 for providing and managing multiple content feeds and supplemental content using an on-screen interactive interface is shown according to one embodiment of the present invention. The system 1000 includes one or more of: (a) an system administrator portal 1002 configured to distribute and manage multiple content feeds and supplemental content using the on-screen interactive interface, (b) a Multimedia Server 106 configured to store all the stream contents, schedule of the stream contents, (c) various content providers 1004-1, 1004-2, . . . , and 1004-N configured to provide various multimedia contents, (d) a Multimedia Control Platform 602 configured to interact with a viewer, (e) a Multimedia Application Programming Interface (API) 802 configured to interact with all user devices, and (f) an end user device 110 configured to configure, receive and display multimedia contents. The system administrator portal 1002, and the content providers 1004-1, 1004-2, . . . , and 1004-N use a network such as the Internet to communicate with the Multimedia Server 106. In certain embodiments, the Multimedia Server 106 is cloud-based. In one embodiment, the Multimedia Control Platform 602 and the Multimedia API 802 are firmware embedded in a set top box, a receiver of multimedia contents, or any multi-function device.

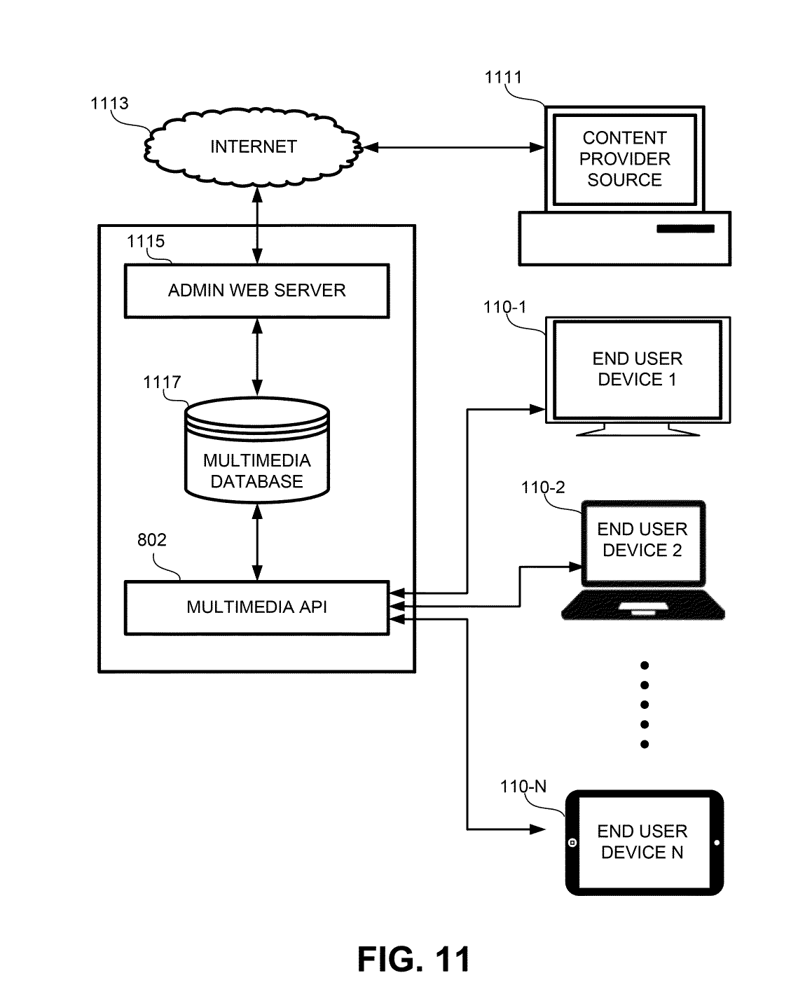

FIG. 11 shows a block diagram of a system where the end user devices receive streaming contents through a multimedia API according to one embodiment of the present invention. The system includes one or more of: (a) a multimedia content provider's computer system 1111 used by a system administrator portal 1002 to schedule and provide multimedia contents, (b) the Internet 1113 configured to communicate and transmit the scheduling information and multimedia contents, (c) an Administrator Web Server 1115 configured to receive communication and transmission of the multimedia contents, (d) a multimedia database 1117 configured to store the scheduling information and multimedia contents received, (e) a multimedia API 802 configured to interact with various end user devices 110-1, 110-2, . . . , and 110-N. In certain embodiments, the system may also include various set top boxes associated with the end user devices 110-1, 110-2, . . . , and 110-N, respectively.

In one embodiment, the system administrator portal 1002 uses the computer system 1111 to schedule and distribute all necessary streaming contents to the multimedia database 1117 through the Internet 1113, and the Admin Web Server 1115. The streaming contents and commercials are transferred to the multimedia database 1117. Viewers access the streaming contents through the end user devices 110-1, 110-2, . . . , and 110-N, and the Multimedia API 802.

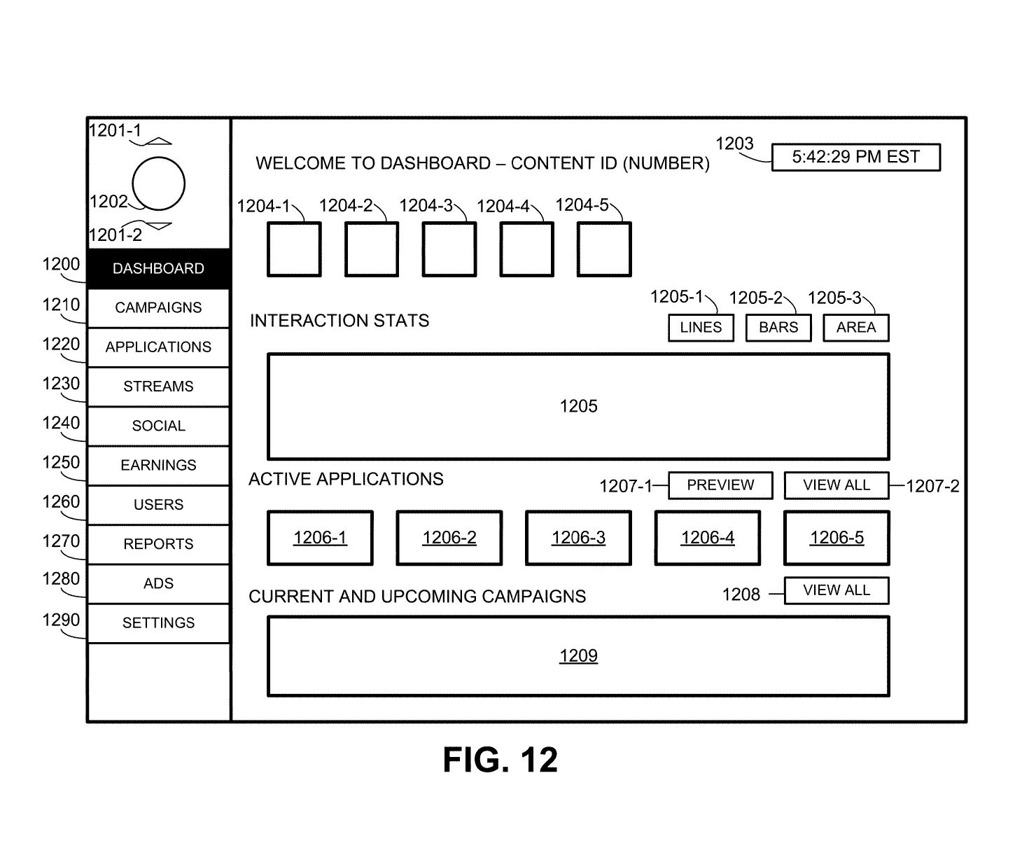

An interactive interface, —a Dashboard—as shown in FIG. 12, is used by the system administrator portal 1002 to provide a snap-shot of activity of the content provider on a home screen. This screen can be modified in the settings to display any type of data relevant for the system administrator portal 1002. The system administrator portal 1002 can drag, drop, remove, and add a variety of statistics for an extra level of customization. The dashboard is accessible by any device using the Internet. It is also mobile friendly and adjustable by screen size in order to view more data.

For security reasons, the system administrator portal 1002 is required to enter a username and a password before he/she can log into the computer system 1111. Once the system administrator portal 1002 is logged in, an interactive interface appears as shown in FIG. 12. The computer system 1111 is used to configure any uploaded content, and the content provider may have multiple videos, multiple streams, and in multiple regions. The interactive interface includes a top level menu bar on the left edge of a display screen. The top level menu bar has: (a) one content number up option 1201-1 and one content number down option 1201-2, (b) a current selected content logo display 1202, (c) a Dashboard menu 1200, (d) a Campaigns menu 1210, (e) an Applications menu 1220, (f) a Streams menu 1230, (g) a Social network menu 1240, (h) an Earnings menu 1250, (i) a Users menu 1260, (j) a Reports menu 1270, (k) an Ads menu 1280, and (l) a Settings menu 1290.

In one embodiment, the content number up option 1201-1 and the content number down option 1201-2 are used for the system administrator portal 1002 to select a content number from a list of available content numbers to configure the streaming contents. Once a stream content is selected, the selected stream content graphic description and its logo are displayed in the content logo display 1202. In one embodiment, the stream content ID (number), the logo and content number are displayed besides the banner “WELCOME TO DASHBOARD”. The top of the screen 1203 displays the current time and time zone information. There are at least 5 clickable options for the system administrator portal 1002 to quickly access some critical information such as a schedule 1204-1, a social network 1204-2, an earnings 1204-3, a statistics 1204-4, and a users 1204-5.

When the Schedule option 1204-1 is selected, the system administrator portal 1002 will be allowed to:
(a) enter/edit/modify schedule of contents, campaigns, icons, and more;
(b) enter/edit/modify a Gantt style chart that displays all items including but not limited to; campaigns, commercials, contents, advertisements, buy it now, shopping modules, notifications, polls, etc.; and
(c) display viewer interaction stats in line graph form to display viewer activity during time period specific streaming content.

When the Social network option 1204-2 is selected, the system administrator portal 1002 will be allowed to enter following information for use in campaigns:
(a) News clippings, articles and content, text content, recipes, etc.;
(b) Press accounts (Associated Press, Reuters, etc.);
(c) Social network Accounts;
(d) Photo sharing Accounts;
(e) Photos and interactive images including flash, gifs, and animations;
(f) Videos (uploaded, linked, and embedded using embed codes);
(g) Programming code;
(h) RSS Feeds; and
(i) Merchant Accounts and Shopping gateways for purchase/commerce authentication. (This may also be in the settings section).

The Social network option 1204-2 will be discussed in detail in the Social network menu 1240.

When the Earnings option 1204-3 is selected, the system administrator portal 1002 will be shown:
(a) the earning for a specific period of time from activities and campaigns, and indicating any new users that are added as fans, followers, and subscribers; and
(b) a breakdown of the earnings by campaign, type of activity, application, content, viewer demographic, time period, period, leading advertisers, location, etc.

The Earnings option 1204-3 will be discussed in detail in the Earnings menu 1250.

When the Statistics option 1204-4 is selected, the system administrator portal 1002 will be shown an umbrella of streams within a content provider family and bird's eye view statistics are displayed. Selecting the Statistics option 1204-4 allows the system administrator portal 1002 to go inside and see the specifics of the stats, add/delete/modify in live time.

When the Users option 1204-5 is selected, the system administrator portal 1002 will be allowed to see viewer activity across the platform and the analytics behind the interactions within the platform. The Users option 1204-5 captures what a viewer is watching, when they watch, if they activate the Interactive Bar, click through of applications, notification viewing, shopping behavior, and demographics. The Users option 1204-5 will be discussed in detail in the Users menu 1260.

In one embodiment, an instant interaction statistics 1205 is displayed on the screen showing Page views and/or total subscribers logged in along a certain time period at a predetermined time interval. This information helps the system administrator portal 1002 to evaluate the effectiveness of the APP icons, and viewer participations. The instant interaction statistics 1205 can be presented in a line format, a bar chart format, and a pie chart format, by the system administrator portal 1002 clicking of a LINES option 1205-1, a BARS option 1205-2, or an AREA option 1205-3, respectively.

In one embodiment, active applications set up with the current content are listed in the ACTIVE APPLICATION area, as shown in FIG. 12. They are the first APP icon 1206-1, the second APP icon 1206-2, the third APP icon 1206-3, the fourth APP icon 1206-4, and the fifth APP icon 1206-5. If more than 5 APP icons are set up, the system administrator portal 1002 can click a “VIEW ALL” option 1207-2 to list all the active APP icons. In one embodiment, a sliding bar can be installed to display all APP icons set up with the current content. A “PREVIEW” option 1207-1 can be used by the system administrator portal 1002 to activate the APP icon to check whether the APP icon is set up correctly.

In one embodiment, a display area 1209 is used to display current and upcoming campaigns. Usually, a predetermined number (for example, five) of top campaigns or top upcoming campaigns are listed. The Ad campaigns in this list can be selected, activated and added to the current content. A “VIEW ALL” option 1208 can be used by the system administrator portal 1002 to see entire collection of current and upcoming campaigns.

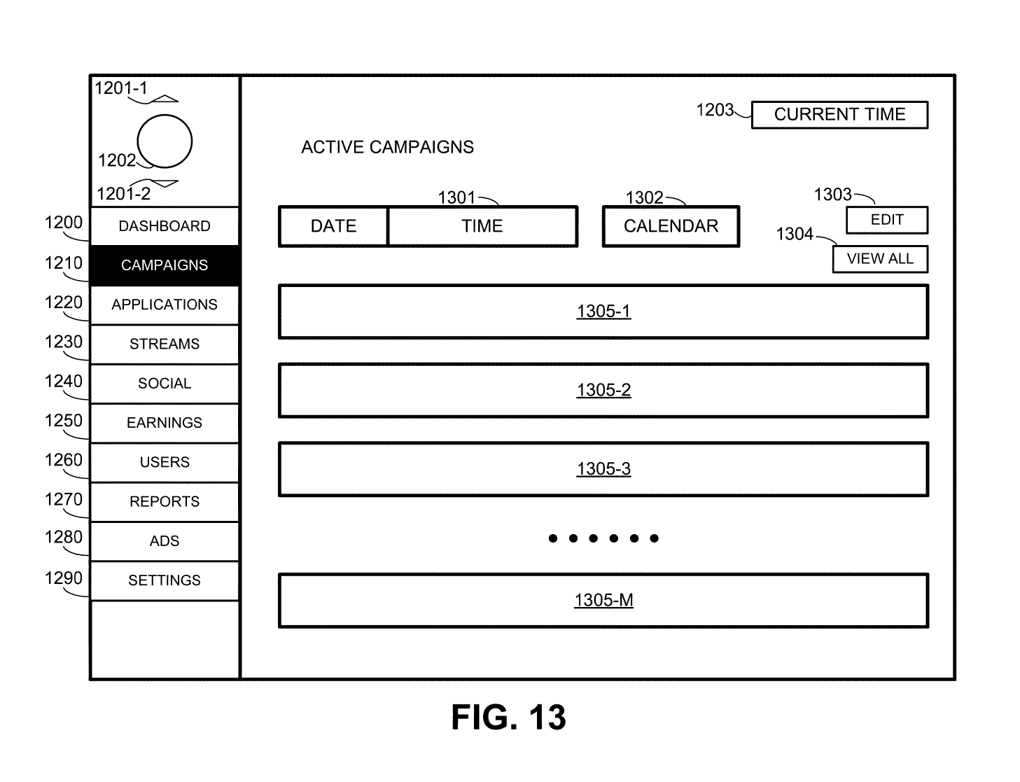

When the CAMPAIGNS menu 1210 on the left edge of the screen is selected, an ACTIVE CAMPAIGNS screen is displayed as shown in FIG. 13 according to one embodiment of the present invention. The ACTIVE CAMPAIGNS screen includes one or more of: (a) a current time, and time zone display 1203 which is the same as the time shown in FIG. 12, (b) Current Date and Time display window 1301, and a Calendar 1302. The system administrator portal 1002 uses the Calendar 1302 to select a date to set up ad campaigns. A few more options such as an “EDIT” option 1303, a “SAVE” option (not shown in FIG. 13), a “SUBMIT” option (not shown in FIG. 13), a “CANCEL” option (not shown in FIG. 13) can be incorporated onto this screen. Various Current Ad Campaigns, or upcoming Ad Campaigns 1305-1, 1305-2, 1305-3, . . . , and 1305-M are listed on this screen. The plurality of Current Ad Campaigns, or upcoming Ad Campaigns can be selected, activated/deactivate at certain time, and removed by the system administrator portal 1002 on this screen.

When the Campaigns Option 1204-2 is selected, all campaigns are managed including menu items, pop ups, interactive apps, icons, notifications, polls, and more. The system administrator portal 1002 can experience demo of campaign by using a “PREVIEW” option. This helps with working through any bugs before campaigns are activated. Any Campaigns can be activated, deactivated, added, modified, and deleted. Based on the system administrator's setting the Campaigns can be set up to be displayed to specific locations, regions, locality, with unlimited duration, infinite screen locations, and more.

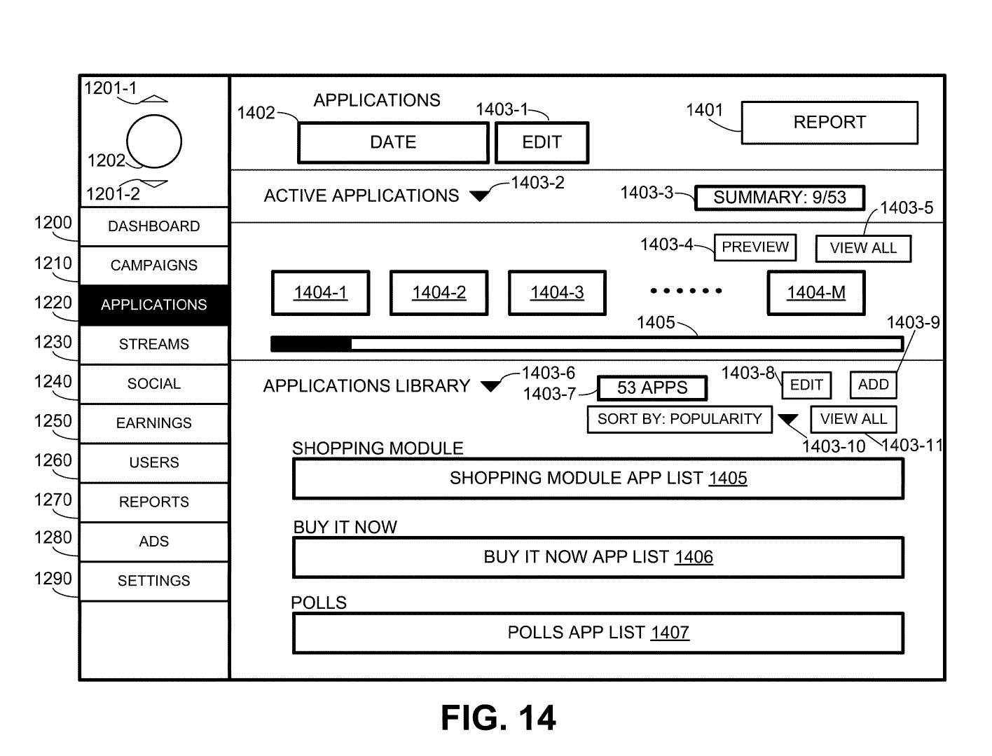

When the APPLICATIONS menu 1220 on the left edge of the screen is selected, an APPLICATIONS screen is displayed as shown in FIG. 14 according to certain embodiments of the present invention. The APPLICATION menu 1220 is a Portal where the system administrator portal 1002 manages all applications, create applications and menus, save and reuse applications, and more.

The APPLICATIONS screen includes one or more of: (a) a “REPORT” option 1401 for the system administrator portal 1002 to generate various reports, (b) a “DATE” option 1402 for showing the results of on a selected date, (c) an “EDIT” option 1403-1 to allow the system administrator portal 1002 to select a different date to display the applications results on that specific date, (d) an pull down menu 1403-2 configured to allow the system administrator portal 1002 to select “ACTIVE APPLICATIONS”, “INACTIVE APPLICATIONS” “ADD APPLICATIONS”, and “REMOVE APPLICATIONS” etc., (e) a “SUMMARY” display window 1403-3 configured to display a summary of total number of APPLICATIONS are listed here and the total number of activated APPLICATIONS, (f) an APP icons display area, and (g) an APPLICATIONS listing area. In the APP icons display area, various APP icons 1404-1, 1404-2, 1404-3, . . . , and 1404-M are shown. When the number of APP icons is greater than 5, a sliding bar 1405 is implemented to allow the system administrator portal 1002 to use to see all available APP icons. On the other hand, a “VIEW ALL” option 1403-5 can also be used to see all available APP icons. A “PREVIEW” option 1403-4 can be used for the system administrator portal 1002 to test/preview a selected APPLICATION.

In one embodiment, the APPLICATIONS listing area includes one or more of: (a) a pull down menu 1403-6 to list an “APPLICATION LIBRARY” configured to display the entire application library, activated APPLICATIONS, inactive APPLICATIONS, type of the application library etc., (b) a total number of APPLICATION in the library window 1403-7, (c) an “EDIT” option 1403-8 configured to allow the system administrator portal 1002 to edit/save/remove applications from the application library, (d) an “ADD” option 1403-9 configured to allow the system administrator portal 1002 to add more applications to the application library, (e) a pull down menu 1403-10 configured to sort the application library in certain ways such as: by priority, by gross revenue, by profit, by alphabetical order, by regions, by contents, by stream contents, by viewer interactions etc., (f) a “VIEW ALL” option 1403-11 configured for the system administrator portal 1002 to see the entire application library in the order based on the settings of the pull down menu 1403-10 by the system administrator portal 1002. In one embodiment, the APPLICATIONS listing area also includes some sections such as a “SHOPPING MODULE APP LIST” 1405 in a SHOPPING MODULE area, a “BUY IT NOW APP LIST” 1406 in a BUY IT NOW area, and a “POLLS APP LIST” 1407 in a POLLS area.

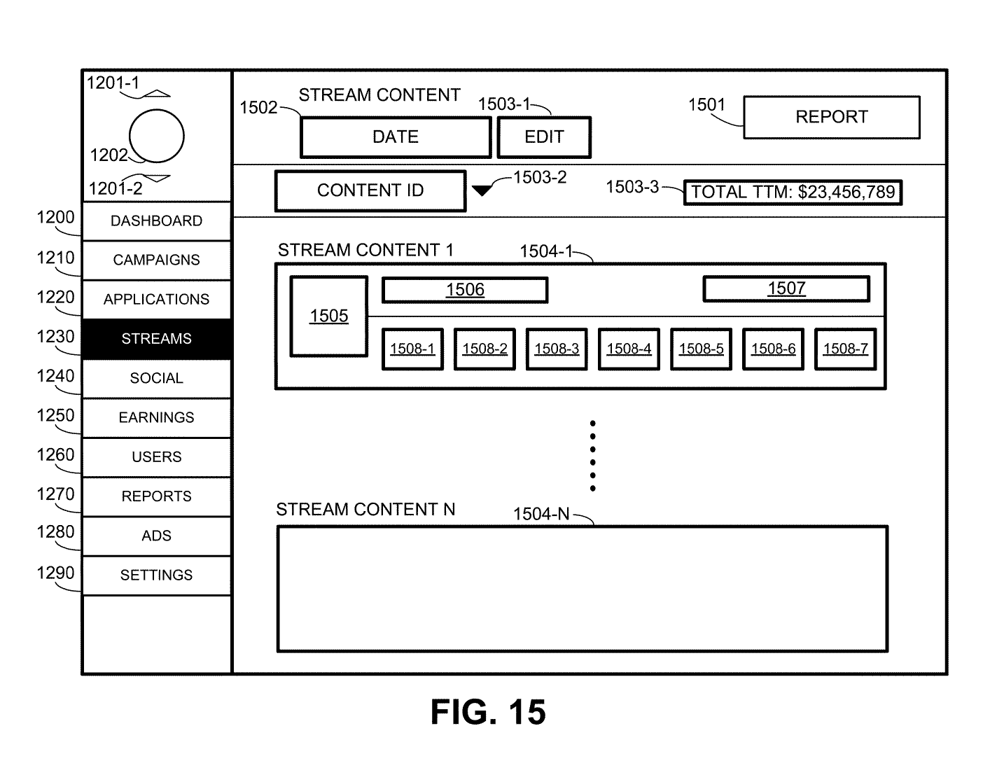

When the Stream menu 1230 on the left edge of the screen is selected, a Stream menu screen is displayed as shown in FIG. 15 according to one embodiment of the present invention. The Stream menu 1230 shows an umbrella of stream contents within the content provider family and bird's eye view statistics are displayed. Using the Stream menu 1230 allows the system administrator portal 1002 to go inside and see the specifics of the stats, add/delete/modify in real time.

The STREAMS screen includes one or more of: (a) a “REPORT” option 1501 for the system administrator portal 1002 to generate various reports related to the stream content selected, (b) a “DATE” option 1502 for showing the current date, (c) an “EDIT” option 1503-1 to allow the system administrator portal 1002 to select a different date to display the stream content statistics on the specific date, (d) an pull down menu 1403-2 configured to allow the system administrator portal 1002 to select “CONTENT ID” to configure the contents for the stream content under such content ID, (e) a “TOTAL TTM” display window 1403-3 configured to display the total revenue of the selected stream contents, and (f) a stream content listing under the content ID.

In the stream content listing area, all stream content under the same selected content ID are listed as Content 1 1504-1, . . . , and Content N 1504-N. Under each content, there are following sub-areas: (a) a summary area 1505 configured to display the total number of activated applications, and total revenue so far, (b) a Content title listing 1506 showing the title of the Content, (c) a total hit counter 1507 showing the number of viewer interactions related to the specific Content, (c) a “PREVIEW” option 1508-1 configured to display what is shown in the selected Content at the moment, (d) an “EDIT option 1508-2 configured to allow the system administrator portal 1002 to edit the contents and applications related to the selected Content, (e) a “RULES” option 1508-3 configured to allow the system administrator portal 1002 to set up certain rules for the contents and application icons to be shown, and their corresponding time periods, (f) an “INTERACTION” option 1508-4 configured to display the system administrator portal 1002 the viewer interactions activities related to the specific Content at the time, (g) a “PAYMENT” option 1508-5 configured to display the total payment to the specific Content at the time, (h) a “SETTINGS” option 1508-6 configured to allow the system administrator portal 1002 to enter screen display preferences, and (i) an “ON/OFF” switch option configured for the system administrator portal 1002 to turn on or turn off the selected specific Content.

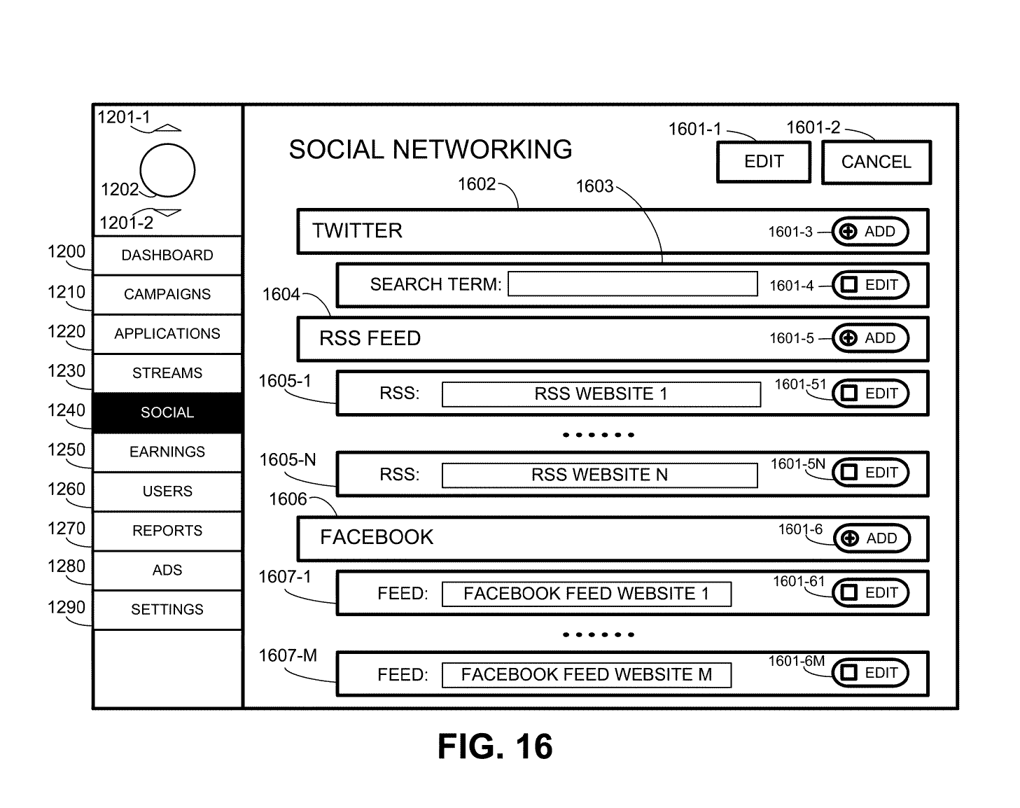

When the Social network menu 1240 on the left edge of the screen is selected, a Social network screen is displayed as shown in FIG. 16 according to one embodiment of the present invention. The system administrator portal 1002 will be allowed to enter following information for use in campaigns: (a) News clippings, articles and content, text content, recipes, etc., (b) Press accounts (Associated Press, Reuters, etc.), (c) Social network Accounts, (d) Photo sharing Accounts, (e) Photos and interactive images including flash, gifs, and animations, (f) Videos (uploaded, linked, and embedded using embed codes), (g) Programming code, (h) RSS Feeds, and (i) Merchant Accounts and Shopping gateways for purchase commerce authentication.

In one embodiment, the Social network screen includes one or more of: (a) an “EDIT” option 1601-1 for the system administrator portal 1002 to edit the Social network screen, adding/editing/removing media outlets shown on the Social network screen, (b) a “CANCEL” option 1601-2 configured to allow the system administrator portal 1002 to cancel the editing and exit the Social network screen, (c) a “TWITTER” Feed 1602, (d) a RSS Feed 1604, (e) a “FACEBOOK” Feed 1606.

In one embodiment, the TWITTER feed 1602 includes an “ADD” option 1601-3 configured to allow the system administrator portal 1002 to add more Twitter Feed. Under the TWITTER feed 1602, a search term display area 1603 is shown for the system administrator portal 1002 to enter other search terms, with an “EDIT” option 1601-4 to allow administrator 1002 to edit the search terms. The RSS feed 1604 includes an “ADD” option 1601-5 configured to allow the system administrator portal 1002 to add more RSS Feeds. Under the RSS feed 1604, various configured RSS feeds 1605-1, . . . , 1605-N is listed with an “EDIT” option 1601-51, . . . , 1601-5N to allow administrator 1002 to edit/set up the plurality of the RSS feeds 1605-1, . . . , 1605-N. The FACEBOOK feed 1606 includes an “ADD” option 1601-6 configured to allow the system administrator portal 1002 to add more FACEBOOK Feeds websites. Under the FACEBOOK feed 1606, various configured FACEBOOK feeds websites 1607-1, . . . , 1607-N is listed with an “EDIT” option 1601-61, . . . , 1601-6M to allow administrator 1002 to edit/set up the plurality of the FACEBOOK feeds websites 1607-1, . . . , 1607-N. More entries such as News clippings, articles and content, text content, recipes can be added here.

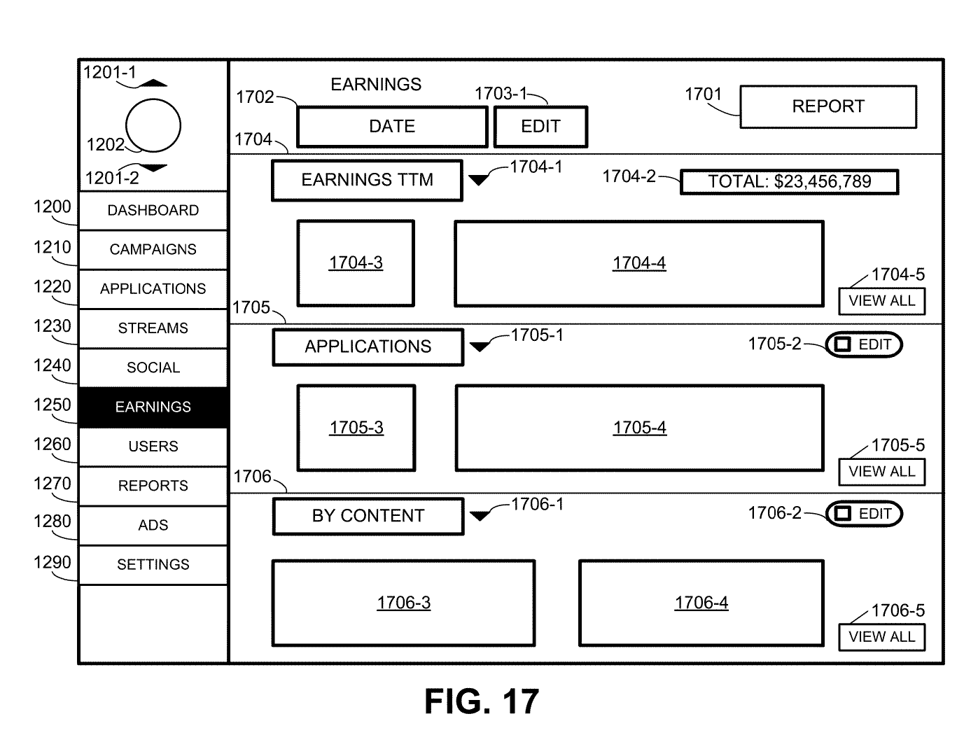

When the EARNINGS menu 1250 on the left edge of the screen is selected, an EARNINGS screen is displayed as shown in FIG. 17 according to one embodiment of the present invention. The EARNINGS screen shows the earning for a specific period of time from activities and campaigns and indicates any new users that are added as fans, followers, and subscribers. Additionally, the EARNINGS screen gives a breakdown of the earnings by campaign, type of activity, application, contents, viewer demographic, time period, period, leading advertisers, location, etc.

In one embodiment, the EARNINGS screen includes one or more of: (a) a “REPORT” option 1701 for the system administrator portal 1002 to generate various reports related to the earnings, (b) a “DATE” option 1702 for showing the current date, (c) an “EDIT” option 1703-1 to allow the system administrator portal 1002 to select a different date to display the earnings statistics on that specific date, and (d) three detail earnings listing areas 1704, 1705, and 1706. The three detail earnings listing areas include: (a) an Earning TTM area 1704, (b) an Earnings by APPLICATION area 1705, and (c) an Earnings by content area 1706.

The Earning TTM area 1704 includes one or more of: (a) a pull down menu 1704-1 configured to allow the system administrator portal 1002 to select accounting methods such as earnings TTM, earnings TTM per content, earnings TTM per content, earnings TTM per region, earnings TTM per age group, etc., (b) a “TOTAL REVENUE” display window 1704-2 configured to display the total revenue so far, (c) a graphic presentation of the earnings 1704-3, (d) a major activities area 1704-4 showing a list of top earnings by ad campaigns; and (e) a “VIEW ALL” option 1704-5 for the system administrator portal 1002 to see the earnings by all ad campaigns in a descending order of total revenue.

The earnings by APPLICATION area 1705 includes one or more of: (a) an pull down menu 1705-1 configured to allow the system administrator portal 1002 to select the earnings by different APPLICATION categories, (b) an “EDIT” option 1705-2 configured to allow the system administrator portal 1002 to edit the contents in the earnings by APPLICATION area 1705, (c) a graphic presentation of the application demographics 1705-3, (d) a top APP area 1705-4 showing a list of top earnings by applications; and (e) a “VIEW ALL” option 1705-5 for the system administrator portal 1002 to see the earnings by all applications in a descending order of total revenue.

The earnings by content area 1706 includes one or more of: (a) an pull down menu 1706-1 configured to allow the system administrator portal 1002 to select the earnings by different content categories, (b) an “EDIT” option 1706-2 configured to allow the system administrator portal 1002 to edit the contents in the earnings by content area 1705, (c) a list of top earnings by content 1706-3 showing a list of top earnings by content, (d) a list of leading revenue advertisers display area 1706-4 showing a list of leading revenue advertisers; and (e) a “VIEW ALL” option 1706-5 for the system administrator portal 1002 to see the earnings by all contents in a descending order of total revenue.

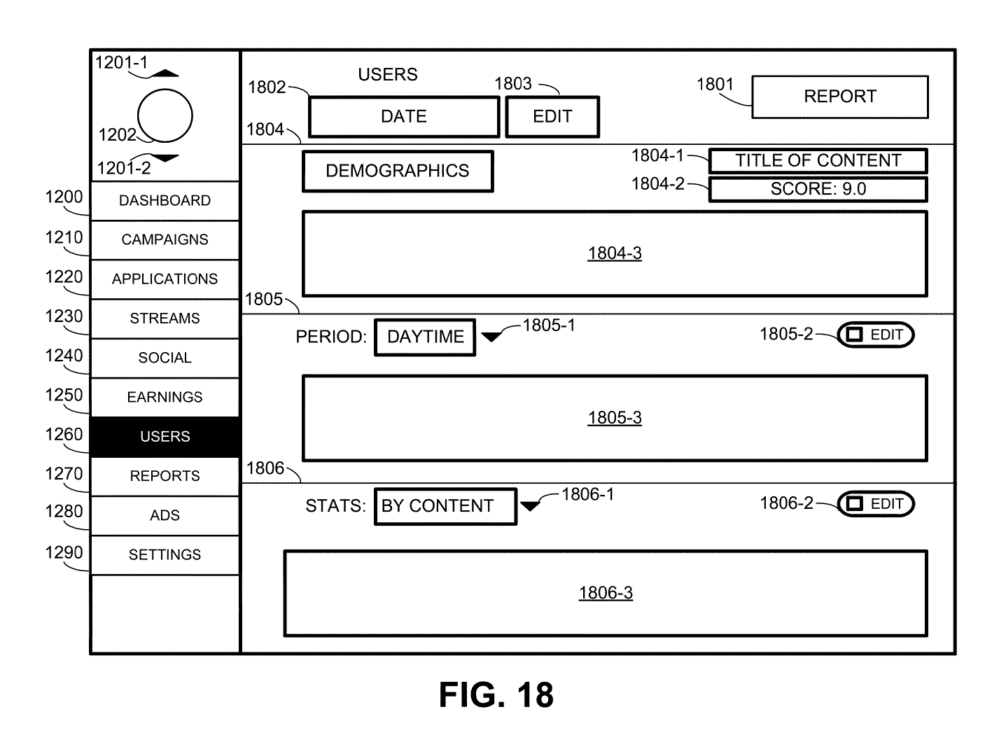

When the USERS menu 1260 on the left edge of the screen is selected, a USERS screen is displayed as shown in FIG. 18 according to one embodiment of the present invention. The USERS screen: (a) displays viewer activity across the platform and the analytics behind the interactions within the platform, (2) captures what a viewer is watching, when they watch, if they activate the Interactive Bar, click through of applications, notification viewing, shopping behavior, and demographics, (c) allows the system administrator portal 1002 to see the behavior of the TV viewers accessing their content, and (d) allows the system administrator portal 1002 to review the contents in a variety of ways and can customize it to the viewers' needs.

In one embodiment, the USERS screen includes one or more of: (a) a “REPORT” option 1801 for the system administrator portal 1002 to generate various reports related to users, (b) a “DATE” option 1802 for showing the current date, (c) an “EDIT” option 1803 to allow the system administrator portal 1002 to select a different date to display the users demographics on that specific date, and (d) three detail viewer display areas 1804, 1805, and 1806. The three detail viewer display areas are: (a) a Demographic Display area 1804, (b) a Viewing Style Display area 1805, and (c) a Statistics Display area 1806.

The Demographic Display area 1804 includes one or more of: (a) the title of the a selected content display window 1804-1, (b) an “ACTIVITY SCORE” display window 1804-2 configured to display an activity score, and (c) a regional/time zone demographics display area 1804-3. The activity score is derived based on a variety of statistics within a specific content and compares the user activity of the specific content to the user activity of all contents within the Multimedia Platform. The successes/score of campaigns are based on a variety of factors from user viewing, durations, click through, bounce rate, sharing, item hits, campaign visibility, demographic response etc. The regional/time zone demographics display area 1804-3 is used to display the behavior of users during a day from east coast to west coast.

The Viewing Style Display area 1805 includes one or more of: (a) a Viewing Style pull down menu 1805-1, (b) an “EDIT” option 1805-2, and (c) a Viewing Style display area 1805-3. The system administrator portal 1002 uses the Viewing Style pull down menu 1805-1 to select: (a) by time (Daytime, Primetime, Nighttime, or any period as defined by the system administrator portal 1002), (b) by Source (Smartphone, Computer, TV, Set-top-box, Interactive TV, Mobile Device (iPod), Tablet PC, all Multi-Function Devices), (c) by Content Provider, (d) by Language, and (e) by Affiliate (local station, news outlet, media distributor, etc.). The “EDIT” option 1805-2 is used to select or edit APP demographics display or user type display. The viewer demographics are populated using a variety of systems including those of MSOs, cable/satellite providers, other stream content providers, external accounts including social network account and other accounts, merchant accounts, market research account, etc. The Viewing Style display area 1805-3 displays: (a) the APP demographics display in a pie chart, line chart or bar chart format with their respective legends, and (b) a viewer type graph. The viewer type graph includes, but not limited to some or all of following statistics:
(a) viewer's gender;
(b) viewer's age group;
(c) viewer's income bracket
(d) viewer's education level;
(e) viewer's ethnicity group;
(f) viewer's location/Region/City;
(g) what viewers like, including (i) the items the viewers like to buy, (ii) the most clicked ads and their location/type/duration, (iii) the most watched content, and (iv) the most used applications;
(h) what viewers buy, including statistics of the most browsed shopping modules/items/products/brands;
(i) viewer's browsing/buying history;
(j) viewer's viewing frequency of advertisement;
(k) viewer's polling feedbacks (by viewer/location/subject/topic/responses);
(l) viewer's application usage statistics, including: (a) Menu impressions, (b) Menu views, (c) Menu location, (d) Menu type, and (e) Icon Type (Notifications, Buy It Now, Menus, Interactive Content Applications);
(m) viewer's click through rate, including click through rate by applications, by campaigns, by interactive content apps, by icons, and by notifications, etc
(n) viewer bounce rate, including rate of viewers moving through the navigations and into external destinations;
(o) viewer viewing duration of (a) advertisements, (b) streaming video, (c) commercials, (d) live stream, (e) applications, and (f) applets and icons; and
(p) viewer interaction duration such as the length of time a viewer interacts with any portion of the multimedia platform.

The Statistics Display area 1806 includes, but not limited to, one or more of: (a) a statistics pull down menu 1806-1, (b) an “EDIT” option 1806-2, and (c) a statistics display area 1806-3. The system administrator portal 1002 uses the statistics pull down menu 1806-1 to select: (a) top watched clips, (b) top watched commercials, (c) top clicked items, (d) top used applications, (e) top campaigns, (f) most saved/added to timeline, and (g) most popular by region, demographic, etc., and the statistics display area 1806-3 displays statistics information the system administrator portal 1002 selected through the statistics pull down menu 1806-1. The display format can be changed by using the “EDIT” option 1806-2.

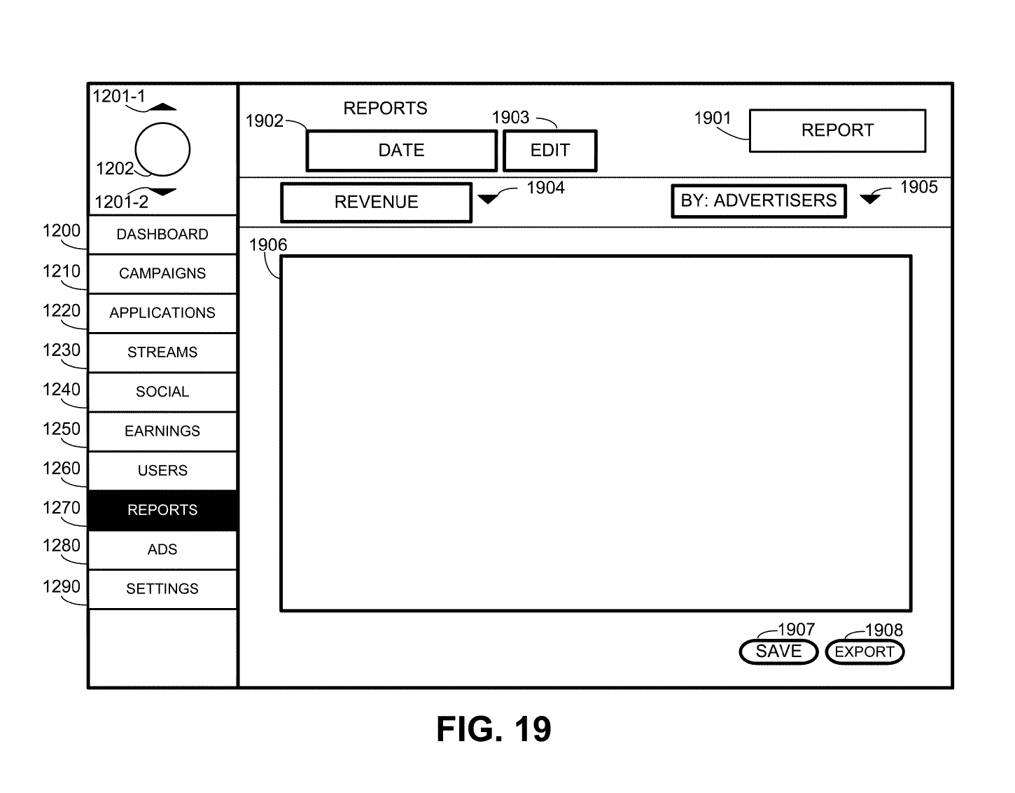

When the REPORTS menu 1270 on the left edge of the screen is selected, a REPORTS screen is displayed as shown in FIG. 19 according to one embodiment of the present invention. The REPORTS screen allows the system administrator portal 1002 to:
(a) generate various reports;
(b) save various reports; and
(c) export various reports in a variety of formats including .xls (Microsoft Excel), PDF, CSV, TSV and other data files for seamless exporting.

In one embodiment, the REPORTS screen includes one or more of: (a) a “REPORT” option 1901 for the system administrator portal 1002 to generate various reports according to the system administrator portal 1002's settings, (b) a “DATE” option 1902 for showing the current date, (c) an “EDIT” option 1903 to allow the system administrator portal 1002 to select a different date to display the statistics on that specific date, (d) a first report pull down menu 1904 to select a first reporting criteria, (e) a second report pull down menu 1905 to select a second reporting criteria, (f) a report display area 1906 for display the report generated, (g) a “SAVE” option 1907 for the system administrator portal 1002 to save the report generated, and (h) an “EXPORT” option 1908 for the system administrator portal 1002 to export the report generated. When the “SAVE” option 1907 is selected, a dialog box will be displayed to allow the system administrator portal 1002 to specify the location of the report. When the “EXPORT” option 1908 is selected, another dialog box will be displayed to allow the system administrator portal 1002 to specify the format of the report.

The reports can be generated on any of the data that is available within the system, for any given time, any given region, any content provider, any content, and any given categories listed above, etc. For example, if the system administrator portal 1002 wants to find out how many women within a certain region viewed an ad or purchased a specific content, they could build that report in the reports section.

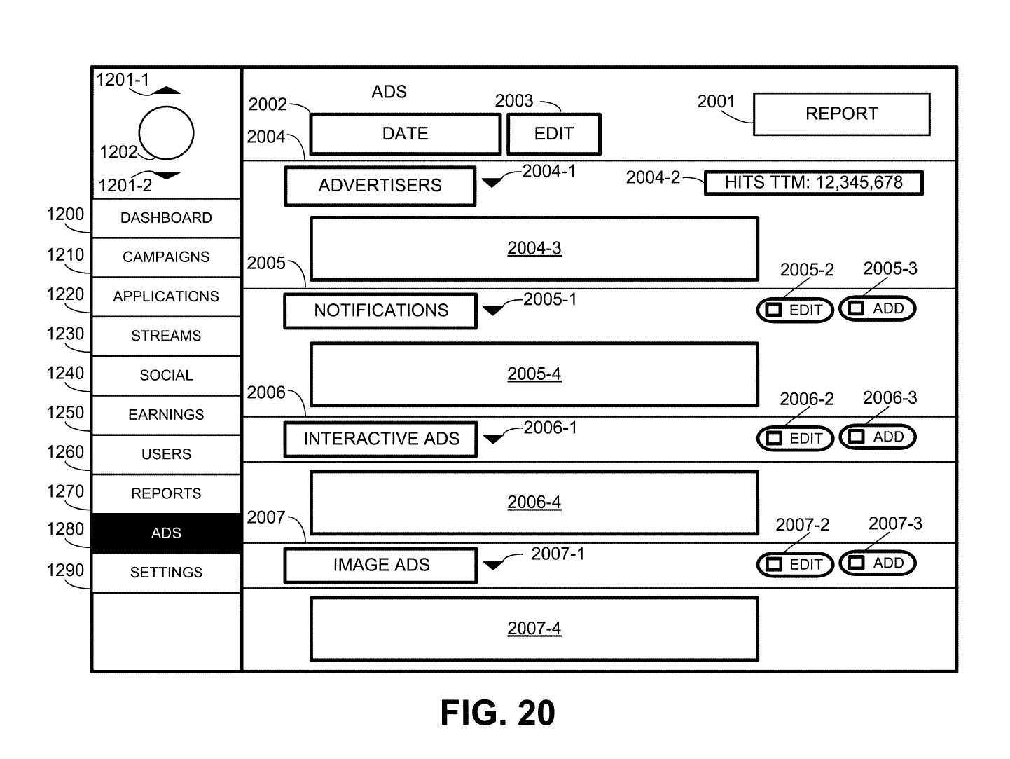

When the ADS menu 1280 on the left edge of the screen is selected, an ADS screen is displayed as shown in FIG. 20 according to one embodiment of the present invention. The ADS screen allows the system administrator portal 1002 to manage the advertisements that will be display and used through various campaign in the Multimedia platform. Here advertisers, MSOs, cable and satellite provider, and content developers are able to understand their viewer base and how the viewers react to specific advertisements. Based on the advertisers' requests, the system administrator portal 1002 schedules certain advertisements to be shown to a variety of demographics and locations. The multimedia platform allows the system administrator portal 1002 to view ad stats in a variety of ways including ranking, popularity, number of hits and success rate. Advertisements can be adjusted—added/modified/deleted in real time based on viewer feedbacks in certain regions, making the advertisement more effective.

In one embodiment, the ADS screen includes one or more of: (a) a “REPORT” option 2001 for the system administrator portal 1002 to generate various reports regarding to the advertisements according to the system administrator portal 1002's settings, (b) a “DATE” option 2002 for showing the current date, (c) an “EDIT” option 2003 to allow the system administrator portal 1002 to select a different date to display the statistics of advertisement on that specific date, and (d) six specific statistics categories display areas.

These six specific statistics categories are: (a) Advertisers 2004, (b) Notifications 2005, (c) Interactive Ads 2006, (d) Image Ads 2007, (e) Video Ads 2008 (not shown in FIG. 20) and (f) Streaming Ads 2009 (not shown in FIG. 20). Each of the six specific statistics categories has a pull down menu for identifying the types, brands, companies, items, and stream contents. The Advertisers display area 2004 includes a total hit display area 2004-2 to display the total number of hits up to the minute. Each of the Notifications display area 2005, Interactive Ads display area 2006, Image Ads display area 2007, Video Ads display area 2008 and Streaming Ads display area 2009 has (a) an “EDIT” option such as 2005-2, 2006-2, 2007-2, 2008-2, and 2009-2, respectively, to allow the system administrator portal 1002 to change specific setting of the display in the corresponding display area, and (b) an “ADD” option such as 2005-3, 2006-3, 2007-3, 2008-3 (not shown in FIG. 20), and 2009-3 (not shown in FIG. 20) to allow the system administrator portal 1002 to add more advertisements into that specific display area.

The ADS screen allows the system administrator portal 1002 to, among other things,
(a) set up campaigns by location,
(b) see ad effectiveness by screen location,
(c) see ad effectiveness by duration,
(d) see ad effectiveness by region, locality, and
(e) view and distribute ads to specific demographics, where the Ad contents, times, screen location can be tailored and fine-tuned to specific viewer demographics.

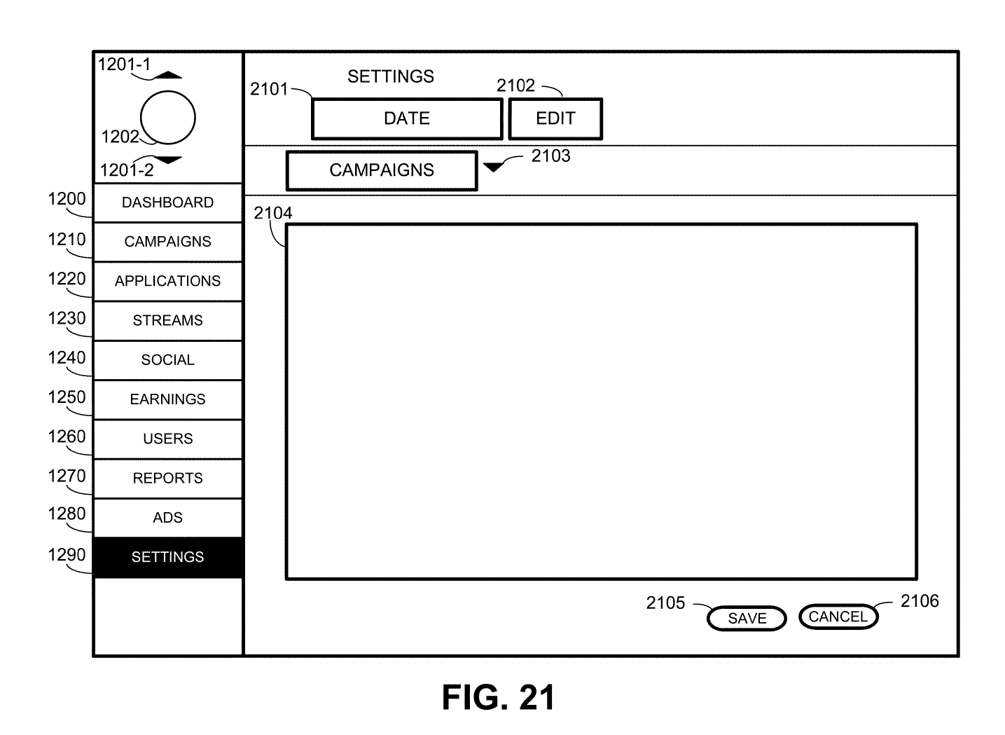

When the SETTINGS menu 1290 on the left edge of the screen is selected, a SETTINGS screen is displayed as shown in FIG. 21 according to one embodiment of the present invention. The SETTINGS screen allows the system administrator portal 1002 to manage the all the account settings including merchant accounts, viewers, subscribers, dashboard display, permissions and restrictions, menu types, etc.

In one embodiment, the SETTINGS screen includes one or more of: (a) a “DATE” option 2101 for showing the current date, (b) an “EDIT” option 2102 to allow the system administrator portal 1002 to select a different date to schedule the settings, and (c) a setting categories pull down menu 2103 for the system administrator portal 1002 to select specific purpose of the settings, (d) a setting display area 2104 configured to display the current settings details, (e) a “SAVE” option 2105 for the system administrator portal 1002 to save current settings, and (f) a “CANCEL” option 2106 for the system administrator portal 1002 to abort or abandon the current settings.

The pull down menu 2103 includes, among other things, following options:
(a) manage all the account settings including merchant account, users, subscribers, dashboard display, permissions and restrictions, menu types, and more;
(b) control integrations using the Multimedia API;
(c) test Campaigns Options;
(d) manage basic, advanced, and custom implementations;
(e) manage mobile and Application implementations; and
(f) manage technical support.

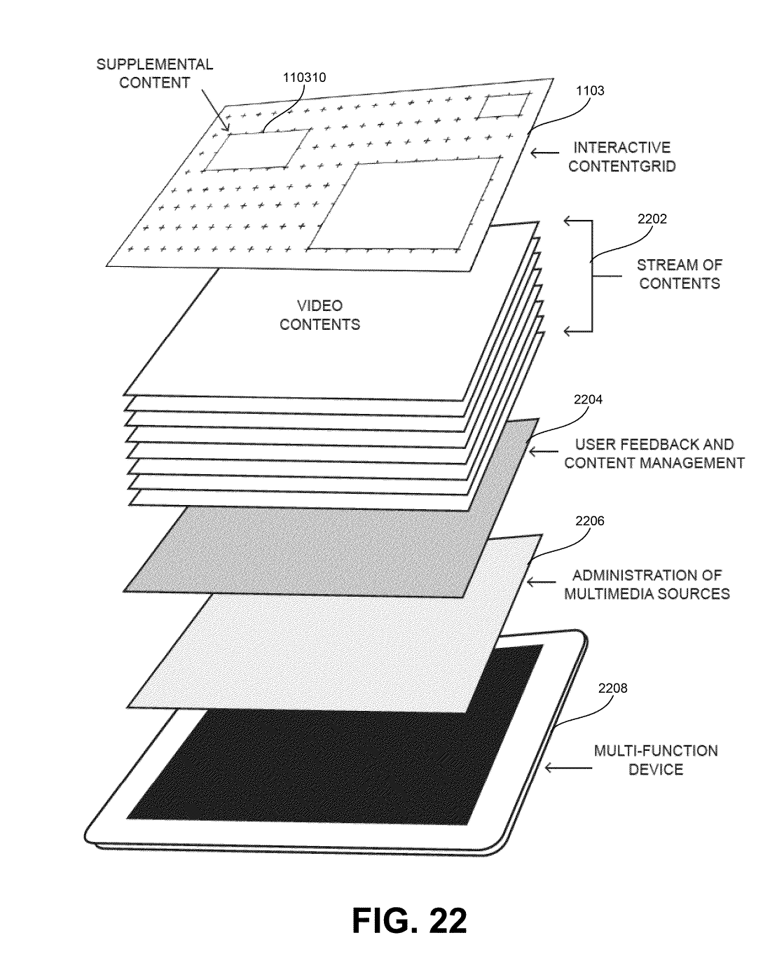

FIG. 22 shows the contents and management information managed through an interactive interface of a multi-function device 2208 according to certain embodiments of the present invention. The contents and management information managed by a viewer through the interactive interface include some or all of following information: (a) interactive content grid 1103, (b) supplemental content 110310, (c) various stream contents 2202, (d) viewer or user feedback and content management information 2204, and (e) administration of multimedia sources 2206.

In one aspect, the present invention relates to a system for a viewer to manage and access multiple content feeds and supplemental content using an on-screen interactive interface. In one embodiment, the system has: (a) a multimedia server configured to integrate streaming contents from various streaming content providers over a network, (b) a multimedia controller configured to receive broadcast contents from various broadcast systems, and the streaming contents from the multimedia server, and (c) a multimedia control platform for a viewer to manage, access, and select the broadcast contents and the streaming contents from the multimedia server through an on-screen interactive interface, and to display selected contents in an end user device.

In one embodiment, the multimedia control platform is embedded in the end user device or the multimedia controller. The end user device includes, but is not limited to, one or more of a multi-function device (monitor with processor), a desktop/laptop computer, a smartphone, a tablet computer, and a smart television.

In one embodiment, the multimedia controller includes one or more of: (a) an internet connection for receiving integrated streaming contents from the multimedia server, and (b) an output to the end user device for displaying the viewer selected contents (can be internal output to device monitor), (c) a cable input for receiving broadcast contents through various cable television providers, (d) an over-air input for receiving broadcast contents through various of direct broadcast television providers, and (e) an output to the end user device for displaying the viewer selected contents. The end user device includes at least one of: a television set and or a smart television set, a desktop and/or laptop computer, a smartphone, a tablet computer, a multi-function display device such as a monitor, or a video projector.

In one embodiment, the on-screen interactive interface includes one or more of: (a) an Interactive Bar at a preset location of display area of the end user device, where the Interactive Bar comprises various application icons for the viewer to navigate and select the broadcast contents and the streaming contents, (b) a notification icon for displaying information to the viewer without being prompted, and (c) an on-screen space for the viewer to retrieve information regarding a piece of content without leaving current display screen. The size of the applications icons, the notification icon, the on-screen space, the viewer preference icon the option links, and the content table is dynamically configured according to the location of the icons, the aspect ratio of the display area of the end user device, and the content to be displayed.

In one embodiment, the broadcast contents and streaming contents further contain advertisements from various advertisers with the advertisement links stored in the multimedia control platform to allow the viewer to access the advertisement content through the links without storing the actual advertisement content in the multimedia server. The viewer's interactions with the advertisements are recorded, and the advertisements are provided to the multimedia server either according to the providers' choice or related to the viewer's preferences, the broadcast contents and/or the streaming contents the viewer selected. The streaming contents and advertisement contents are collected, consolidated and tagged by the content providers, and made available to the viewer through the multimedia server and the multimedia control platform.

In one embodiment, the broadcast contents, the streaming contents and advertisement contents are managed and accessed by the viewer through a transparent content grid of the on-screen interactive interface. The transparent content grid includes one or more of: (a) a grid determined by screen dimension information that is stored based on the user's input, (b) various application icons each having a menu for displaying available options to the viewer to select, where these application icons can be rearranged, placed, created, deleted and managed by the user, (c) the notification icon for displaying information to the viewer without being prompted, (d) the on-screen space for the viewer to retrieve information regarding a piece of content without leaving current display screen, (e) a viewer preference icon for the viewer to setup the arrangement of contents, applications, option links, notifications, viewer profile management and parental controls, (f) various option links that are linked to various option link applications, and (g) a content table for user's easy access to the contents available to the user.

In one embodiment, the on-screen interactive interface is configured to allow the viewer to interact with vendors of commercial products advertised: (a) to watch a commercial displayed simultaneously with other content display, (b) to visit a shopping center by clicking the icon for shopping center, (c) to click any option links on an advertisement bar, and (d) to make an on-screen purchase through floating option links on the transparent content grid.

In one embodiment, the history of the viewer's interactions is saved for future reference and targeted advertisement delivery. The viewer's interactions include one or more of: (a) the applications selected by the viewer, (b) the menu selected by the viewer, (c) the notification icon shown to the viewer, (d) the information retrieved by the viewer, (e) the advertisements shown to the viewer, (f) the advertisements selected by the viewer, (g) the products the viewer searched by the viewer, (h) the products the viewer purchased by the viewer, (i) how often the viewer make a purchase, (j) how often the viewer uses the social network, (k) daily content viewing hours, (l) statistics of the viewer's viewing habit, (m) the content selected by the viewer, (n) the device viewer is accessing the content with (smartphone, computer . . . etc.), (o) the level of spending by the viewer, and (p) the spending habits of the viewer.

In one embodiment, the on-screen interactive interface is configured to allow the viewer to interact through a touch screen means of a smartphone, a tablet computer, and an option pushing means of a remote control or a keyboard of a television set, a monitor, a computer, a smartphone, or a tablet computer. The on-screen interactive interface is configured to allow the viewer to perform on-screen purchase by: (a) clicking a floating option-link on the transparent content grid in front of streaming video and content from the providers, (b) selecting commercial products to purchase using the on-screen interactive interface, (c) making purchase authorization from a previously saved advertisement, and (d) making PIN confirmation before purchase, with the PIN being a digital code created by the viewer when the viewer's account is first setup.

In another aspect, the present invention relates to a method for a viewer to manage and access multiple content feeds and supplemental content using an on-screen interactive interface. In one embodiment, the method includes one or more steps of: (a) collecting, consolidating and tagging streaming contents from a content provider and making the streaming contents available to the viewer through a multimedia server and a multimedia controller, (b) receiving broadcast contents or the schedule of the broadcast contents through the multimedia controller and making the broadcast contents or its schedule available to the viewer through the multimedia controller, (c) managing and organizing the broadcast contents and streaming contents by the viewer through an on-screen interactive interface of a multimedia control platform, scheduling the broadcast contents and streaming contents to be displayed to the viewer according to the schedule of the broadcast contents and the streaming contents and user's selection, and (d) displaying the broadcast contents and the streaming contents the viewer selected on an end user device. In one embodiment, the multimedia control platform is embedded in the end user device. In another embodiment, the multimedia control platform is embedded in a multimedia controller.

In one embodiment, the multimedia controller includes one or more of: (a) an internet connection for receiving integrated streaming contents from the multimedia server, and (b) an output to the end user device for displaying the viewer selected contents (can be internal output to device monitor), (c) a cable input for receiving broadcast contents through various cable television providers, (d) an over-air input for receiving broadcast contents through various of direct broadcast television providers, and (e) an output to the end user device for displaying the viewer selected contents. The end user device includes at least one of: a television set and or a smart television set, a desktop and/or laptop computer, a smartphone, a tablet computer, a multi-function display device such as a monitor, or a video projector.

In certain embodiments, the multimedia control platform includes one or more of: (a) an Interactive Bar at a preset location of display area of the end user, (b) a notification icon for displaying information to the viewer without being prompted, and (c) an on-screen space for the viewer to retrieve information regarding a piece of content without leaving current display screen. The Interactive Bar includes various application icons for the viewer to navigate and select the broadcast contents and the streaming contents. The size of the applications icons, the notification icon, the on-screen space, the viewer preference icon the option links, and the content table is dynamically configured according to the location of the icons, the aspect ratio of the display area of the end user device, and the content to be displayed.

In one embodiment, the broadcast contents and streaming contents further contain advertisements from various advertisers with the advertisement links stored in the multimedia control platform to allow the viewer to access the advertisement content through the links without storing the actual advertisement content in the multimedia server. The viewer's interactions with the advertisements are recorded, and the advertisements are provided to the multimedia server either according to the providers' choice or related to the viewer's preferences, the broadcast contents and the streaming contents the viewer selected. The streaming contents and advertisement contents are collected, consolidated and tagged by the content provider, and made available to the viewer through the multimedia server and the multimedia control platform.

In one embodiment, the broadcast contents, the streaming contents and advertisement contents are managed and accessed by the viewer through a transparent content grid of the on-screen interactive interface. The transparent content grid includes one or more of: (a) a grid determined by screen dimension information that is stored based on the user's input, (b) the plurality of application icons each having a menu for displaying available options to the viewer to select, and these application icons can be rearranged, placed, created, deleted and managed by the user, (c) the notification icon for displaying information to the viewer without being prompted, (d) the on-screen space for the viewer to retrieve information regarding a piece of content without leaving current display screen, (e) a viewer preference icon for the viewer to setup the arrangement of contents, applications, option links, notifications, viewer profile management and parental controls, (f) various option links that are linked to various option link applications, and (g) a content table for user's easy access to the contents available to the user.

In one embodiment, the on-screen interactive interface is configured to allow the viewer to interact with vendors of commercial products advertised: (a) to watch a commercial displayed simultaneously with other content display, (b) to visit a shopping center by clicking the icon for shopping center, (c) to click any option links on an advertisement bar, and (d) to make an on-screen purchase through floating option links on the transparent content grid.

In one embodiment, the history of the viewer's interactions is saved for future reference and targeted advertisement delivery. The viewer's interactions include one or more of: (a) the applications selected by the viewer, (b) the menu selected by the viewer, (c) the notification icon shown to the viewer, (d) the information retrieved by the viewer, (e) the advertisements shown to the viewer, (f) the advertisements selected by the viewer, (g) the products the viewer searched by the viewer, (h) the products the viewer purchased by the viewer, (i) how often the viewer make a purchase, (j) how often the viewer uses the social network, (k) daily content viewing hours, (l) statistics of the viewer's viewing habit, (m) the content selected by the viewer, (n) the device viewer is accessing the content with (smartphone, computer . . . etc.), (o) the level of spending by the viewer, and (p) the spending habits of the viewer.

In one embodiment, the on-screen interactive interface is configured to allow the viewer to interact through a touch screen means of a smartphone, a tablet computer, and an option pushing means of a remote control or a keyboard of a television set, a monitor, a computer, a smartphone, or a tablet computer. The on-screen interactive interface is configured to allow the viewer to perform on-screen purchase by: (a) clicking a floating option-link on the transparent content grid in front of streaming video and content from the providers, (b) selecting commercial products to purchase using the on-screen interactive interface, (c) making purchase authorization from a previously saved advertisement, and (d) making PIN confirmation before purchase, with the PIN being a digital code created by the viewer when the viewer's account is first setup.

In yet another aspect, the present invention relates to a non-transitory storage medium having computer-executable instructions stored on it. When the computer-executable instructions are executed by a processor, the computer-executable instructions cause the processor to execute a method for a viewer to manage and access multiple content feeds and supplemental content using an on-screen interactive interface. In one embodiment, the method includes one or more steps of: (a) collecting, consolidating and tagging broadcasting contents and streaming contents from content providers and making these contents available to the viewer through a multimedia server and a multimedia controller, (b) managing and organizing the contents by the viewer through an on-screen interactive interface of a multimedia control platform, and (c) displaying the contents the viewer selected on an end user device. In one embodiment, the multimedia control platform is embedded in the end user device. In another embodiment, the multimedia control platform is embedded in a multimedia controller.

In one embodiment, the multimedia controller includes one or more of: (a) an internet connection for receiving integrated streaming contents from the multimedia server, and (b) an output to the end user device for displaying the viewer selected contents (can be internal output to device monitor), (c) a cable input for receiving broadcast contents through various cable television providers, (d) an over-air input for receiving broadcast contents through various of direct broadcast television providers, and (e) an output to the end user device for displaying the viewer selected contents. The end user device includes at least one of: a television set and or a smart television set, a desktop and/or laptop computer, a smartphone, a tablet computer, a multi-function display device such as a monitor, or a video projector.

In one embodiment, the multimedia control platform includes one or more of: (a) an Interactive Bar at a preset location of display area of the end user, (b) a notification icon for displaying information to the viewer without being prompted, and (c) an on-screen space for the viewer to retrieve information regarding a piece of content without leaving current display screen. The Interactive Bar includes various application icons for the viewer to navigate and select the broadcast contents and the streaming contents. The size of the applications icons, the notification icon, the on-screen space, the viewer preference icon the option links, and the content table is dynamically configured according to the location of the icons, the aspect ratio of the display area of the end user device, and the content to be displayed.

In one embodiment, the broadcast contents and streaming contents further contain advertisements from various advertisers with the advertisement links stored in the multimedia control platform to allow the viewer to access the advertisement content through the links without storing the actual advertisement content in the multimedia server. The viewer's interactions with the advertisements are recorded, and the advertisements are provided to the multimedia server either according to the providers' choice or related to the viewer's preferences, the broadcast contents and the streaming contents the viewer selected. The streaming contents and advertisement contents are collected, consolidated and tagged by the content provider, and made available to the viewer through the multimedia server and the multimedia control platform.

In one embodiment, the broadcast contents, the streaming contents and advertisement contents are managed and accessed by the viewer through a transparent content grid of the on-screen interactive interface. The transparent content grid includes one or more of: (a) a grid determined by screen dimension information that is stored based on the user's input, (b) the plurality of application icons each having a menu for displaying available options to the viewer to select, and that these application icons can be rearranged, placed, created, deleted and managed by the user, (c) the notification icon for displaying information to the viewer without being prompted, (d) the on-screen space for the viewer to retrieve information regarding a piece of content without leaving current display screen, (e) a viewer preference icon for the viewer to setup the arrangement of contents, applications, option links, notifications, viewer profile management and parental controls, (f) various option links that are linked to various option link applications, and (g) a content table for user's easy access to the contents available to the user.

In one embodiment, the on-screen interactive interface is configured to allow the viewer to interact with vendors of commercial products advertised: (a) to watch a commercial displayed simultaneously with other content display, (b) to visit a shopping center by clicking the icon for shopping center, (c) to click any option links on an advertisement bar, and (d) to make an on-screen purchase through floating option links on the transparent content grid.

In one embodiment, the history of the viewer's interactions is saved for future reference and targeted advertisement delivery. The viewer's interactions include one or more of: (a) the applications selected by the viewer, (b) the menu selected by the viewer, (c) the notification icon shown to the viewer, (d) the information retrieved by the viewer, (e) the advertisements shown to the viewer, (f) the advertisements selected by the viewer, (g) the products the viewer searched by the viewer, (h) the products the viewer purchased by the viewer, (i) how often the viewer make a purchase, (j) how often the viewer uses the social network, (k) daily television viewing hours, (l) statistics of the viewer's viewing habit, (m) the current content selected by the viewer, (n) the device viewer is accessing the content with (smartphone, computer . . . etc.), (o) the level of spending by the viewer, and (p) the spending habits of the viewer.

In one embodiment, the on-screen interactive interface is configured to allow the viewer to interact through a touch screen means of a smartphone, a tablet computer, and an option pushing means of a remote control or a keyboard of a television set, a monitor, a computer, a smartphone, or a tablet computer. The on-screen interactive interface is configured to allow the viewer to perform on-screen purchase by: (a) clicking a floating option-link on the transparent content grid in front of streaming video and content from the providers, (b) selecting commercial products to purchase using the on-screen interactive interface, (c) making purchase authorization from a previously saved advertisement, and (d) making PIN confirmation before purchase, with the PIN being a digital code created by the viewer when the viewer's account is first setup.

In yet another aspect, the present invention relates to a system for a system administrator to distribute and manage multiple content feeds and supplemental content using an on-screen interactive interface. The system includes one or more of: (a) various multimedia sources configured to provide multiple content feeds and supplemental contents, (b) a multimedia server configured to integrate multiple content feeds and supplemental contents over a network, (c) a computer communicatively coupled to the network configured for the system administrator to manage the schedule and the source of the plurality of multimedia sources, and (d) a multimedia control platform for various viewers to manage, access, and select the multiple content feeds and supplemental contents from the multimedia server through an on-screen interactive interface, and to display selected contents on the end user devices.

In one embodiment, the multiple content feeds and supplemental contents may include one or more of these content sources: (a) real time broadcast contents, (b) multimedia streaming contents, (c) supplemental multimedia contents, (d) multimedia content management information, and (e) advertisement contents. The multimedia control platform includes a multimedia API configured to allow the end user devices to access the multiple content feeds and supplemental contents. In one embodiment, the multimedia control platform is embedded in an end user device. In another embodiment, the multimedia control platform is embedded in a multimedia controller.

In one embodiment, the multimedia controller includes one or more of: (a) an internet connection for receiving integrated streaming contents from the multimedia server, and (b) an output to the end user device for displaying the viewer selected contents (can be internal output to device monitor), (c) a cable input for receiving broadcast contents through various cable television providers, (d) an over-air input for receiving broadcast contents through various of direct broadcast television providers, and (e) an output to the end user device for displaying the viewer selected contents. The end user device includes at least one of: a television set and or a smart television set, a desktop and/or laptop computer, a smartphone, a tablet computer, a multi-function display device such as a monitor, or a video projector.

In one embodiment, the multimedia server has one or more of: (a) an admin web server configured to allow the system administrator to distribute and manage the multiple content feeds and supplemental contents, and (b) a multimedia database configured to store all system configuration information, the schedules of the broadcast contents and, links to multimedia contents and streaming contents.

In one embodiment, the on-screen interactive interface includes one or more of: (a) a content selection area for the system administrator to change the current content, (b) a menu bar area configured to provide the system administrator various options to select, (c) a title area configured to display the title of the current content selected by the system administrator, and (d) a main display area configured to display information related to the current content and the specific option the system administrator selected. The location and the size of the content selection area, the menu bar area, the title area, and the main display area are setup by the system administrator through a menu option setting.

In one embodiment, the content selection area has a content display configured to display the title and logo of the current content, and the ability to select another content from the same content provider, a content number up option and a content number down option configured to allow the system administrator to change current content.

In one embodiment, the menu bar area includes one or more of: (a) a Dashboard option to provide the system administrator an overview of the current content, (b) a Campaigns option to allow the system administrator to set up various campaigns related to the current content, (c) an applications option to allow the system administrator to set up various applications related to the current content, (d) a streams option to allow the system administrator to set up various streams related to the current content, (e) a social network option to allow the system administrator to set up various social network access available to the current content, (f) an earnings option to display the system administrator the earning information related to the current content, (g) a users option to display the system administrator the statistics of user interactions, (h) a reports option configured to allow the system administrator to generate various reports related to the current content, (i) an ADS option configured to allow the system administrator to set up various advertisements related to the current content, and (j) a settings option configured to allow the system administrator to set up the system administrator's preferences.

In one embodiment, the display area of the Dashboard option includes one or more of: (a) a Schedule option configured to allow the system administrator to schedule multimedia contents, television programs and advertisement contents, (b) a social network option configured to allow the system administrator to quickly access the social network outlets, (c) an Earnings option configured to display up to the minute earnings, (d) a Statistics option configured to display the user interactions statistics, (e) a Users option configured to display detailed information related to the users, (f) a graphical presentation of the statistics of user interactions, (g) various applications icons available for the current content, and (h) various campaigns available to the system administrator to use now or in the future.

In one embodiment, the Schedule option of the Dashboard option is configured for the system administrator to: (a) edit schedule of contents, campaigns, applications icons, (b) edit a Gantt style chart that displays all items including: campaigns, commercials, contents, advertisements, buy it now, shopping modules, notifications, polls, and (c) display user interaction statistics in line graph form to display viewer activity during time period specific streaming content. The Earnings option of the Dashboard option is configured to display: (a) the earning for a specific period of time from activities and campaigns, and indicating any new users that are added as fans, followers, and subscribers, and (b) a breakdown of the earnings by campaign, type of activity, application, content, viewer demographics, time period, period, leading advertisers, location, etc. The Statistics option of the Dashboard option is configured to display an umbrella of streams within a content provider family and bird's eye view statistics. The Users option of the Dashboard option is configured to display viewer activity across a multimedia platform and the analytics behind the interactions within the platform.

In one embodiment, the graphical presentation of the statistics of user interactions includes one or more of: a line graph, a bar graph, and a pie chart. The plurality of applications icons available for the current content is displayed in a list form, a matrix form, an abbreviated form, a horizontal icon view with a sliding bar to display a predetermined number of applications icons, in a predetermined order setup by the system administrator. The plurality of applications icons available for the current content is scheduled and activated by the system administrator through the Applications option. The system administrator can test the plurality of application icons by selecting preview option.

In one embodiment, the plurality of campaigns available to the system administrator to use is displayed in a list form, a matrix form, and an abbreviated form, in a predetermined order setup by the system administrator. The plurality of campaigns available to the system administrator to use is scheduled and activated by the system administrator through the Campaigns option. The Campaigns option allows the system administrator to manage menu items, pop ups, interactive apps, icons, notifications, polls. The system administrator can experience demo of campaign by using a “PREVIEW” option.

In one embodiment, the Applications option allows the system administrator to: (a) generate reports related to the plurality of Applications icons, (b) select a specific date to see the users interactions on the specific date, (c) select a different date to display the applications results on that specific date, (d) select various option from a pull-down menu to edit, schedule and activate applications icons, (e) display a summary of total number of applications icons are listed here and the total number of activated applications icons, and (f) display the plurality of the applications icons available. The Applications option has an Application library and the Application library contains: (a) various applications icons, (b) various shopping module applications, (c) various “Buy it Now” applications, and (d) various Polls applications.

In one embodiment, the Streams option allows the system administrator to: (a) generate various reports related to the stream selected, (b) display the current date, (c) select a different date to display the stream statistics on the specific date, (d) select “CONETENT ID” to configure the contents for the streams under such content id, (e) display the total revenue of the selected stream(s), and (f) a content listing under the content ID.

In one embodiment, the social network option is configured for the system administrator to enter following information for use in campaigns: (a) News clippings, articles and content, text content, recipes, etc., (b) Press accounts (Associated Press, Reuters, etc.), (c) Social network Accounts, (d) Photo sharing Accounts, (e) Photos and interactive images including flash, gifs, and animations, (f) Videos (uploaded, linked, and embedded using embed codes), (g) Programming code, (h) RSS Feeds, and (i) Merchant Accounts and Shopping gateways for purchase/commerce authentication.

In one embodiment, the Earnings option is configured to display: (a) the earning for a specific period of time from activities and campaigns, and indicating any new users that are added as fans, followers, and subscribers, and (b) a breakdown of the earnings by campaign, type of activity, application, content, viewer demographics, time period, period, leading advertisers, location, etc.

In one embodiment, the Users option is configured to: (a) generate various reports related to users, (b) select a different date to display the users demographics on that specific date, (c) display users Demographics display, (d) display Viewing Style Display, and (e) display Statistics Display. An activity score is derived based on a variety of statistics within a piece of content and compares the user activity of the content to the user activity of all the content within the Multimedia Platform. The users Demographics display includes the following user statistics: (a) viewer's gender, (b) viewer's age group, (c) viewer's income bracket, (d) viewer's education level, (e) viewer's ethnicity group, (f) viewer's location, Region, and City, (g) what viewers like, including: the items the viewers like to buy, the most clicked ads, the most watched content, and the most used applications, (h) what viewers buy, including statistics of the most browsed shopping modules, items, products, and brands, (i) viewer's browsing and buying history, (j) viewer's viewing frequency of advertisement, (k) viewer's polling feedbacks based on viewer, location, subject, topic, and responses, (l) viewer's application usage statistics, including: Menu impressions, Menu views, Menu location, Menu type, and Icon Type such as Notifications, Buy It Now, Menus, Interactive Content Applications, (m) viewer's click through rate, including click through rate by applications, by campaigns, by interactive content apps, by icons, and by notifications, etc., (n) viewer bounce rate, including rate of viewers moving through the navigations and into external destinations, (o) viewer viewing duration of advertisements, streaming video, commercials, live stream, applications, and applets and icons, and (p) viewer interaction duration such as the length of time a viewer interacts with any portion of the multimedia platform.

In one embodiment, the Viewing Style Display has a Viewing Style pull down menu. The Viewing Style pull down menu has following options: by Period, by Source, by Content Provider, by Language, and by Affiliate. The by Time option includes some or all of: Daytime, Primetime, Nighttime, or any period as defined by the system administrator. The by Source option includes one or more of: Smartphone, Computer, Set-top-box, Interactive TV, Mobile Device (iPod), Tablet PC, and any other Multi-Function Device with a processor and internet access. The by Content Provider option includes all owners of content that has been submitted to the multimedia platform and/or media servers. The by Affiliate option includes one or more of: local station, news outlet, and media distributor.

In one embodiment, the Reports option is configured to: (a) generate various reports, (b) save various reports, and (c) export various reports. The various reports are exported in at least one of the following formats: .xls (Microsoft Excel), PDF, CSV, TSV and other data files for seamless exporting.

In one embodiment, the ADS option is configured to allow the system administrator to: (a) manage various advertisements that will be display and used through various campaign currently or in the future, (b) set up campaigns by location, (c) see ad effectiveness by screen location, (d) see ad effectiveness by duration, (e) see ad effectiveness by region, locality, and (f) view and distribute ads to specific demographics. The Ad contents, times, screen location can be tailored and fine-tuned to specific viewer demographics. The statistics of the advertisements includes one or more of: (a) Advertisers, (b) Notifications, (c) Interactive Ads, (d) Image Ads, (e) Video Ads, and (f) Streaming Ads.

In one embodiment, the Settings option is configured to allow the system administrator to: (a) manage all the account settings including merchant account, users, subscribers, dashboard display, permissions and restrictions, menu types, and more, (b) control integrations using the Multimedia API, (c) test Campaigns Options, (d) manage basic, advanced, and custom implementations, (e) manage mobile and Application implementations, and (f) manage technical support.

In a further aspect, the present invention relates to a method for a system administrator to distribute and manage multiple content feeds and supplemental content using an on-screen interactive interface. In one embodiment, the method includes one or more steps of: (a) logging into a computer communicatively coupled to a network, (b) accessing a multimedia server configured to integrate multiple content feeds and supplemental contents over the network, and receive the multiple content feeds and supplemental contents from various multimedia sources, (c) managing operations and sources of the multiple content feeds and supplemental contents, and (d) providing the schedules and sources of the multiple content feeds and supplemental contents to a multimedia control platform for various viewers to manage, access, select, and display the selected contents from the multimedia server to selected end user devices.

In one embodiment, the multiple content feeds and supplemental contents may include one or more of these content sources: (a) real time broadcast contents, (b) multimedia streaming contents, (c) supplemental multimedia contents, (d) multimedia content management information, and (e) advertisement contents. The multimedia control platform includes a multimedia API configured to allow the end user devices to access the multiple content feeds and supplemental contents. In one embodiment, the multimedia control platform is embedded in an end user device. In another embodiment, the multimedia control platform is embedded in a multimedia controller.

In one embodiment, the multimedia controller includes one or more of: (a) an internet connection for receiving integrated streaming contents from the multimedia server, and (b) an output to the end user device for displaying the viewer selected contents (can be internal output to device monitor), (c) a cable input for receiving broadcast contents through various cable television providers, (d) an over-air input for receiving broadcast contents through various of direct broadcast television providers, and (e) an output to the end user device for displaying the viewer selected contents. The end user device includes at least one of: a television set and or a smart television set, a desktop and/or laptop computer, a smartphone, a tablet computer, a multi-function display device such as a monitor, or a video projector.

In one embodiment, the multimedia server includes one or more of: (a) an admin web server configured to allow the system administrator to distribute and manage the multiple content feeds and supplemental contents, and (b) a multimedia database configured to store all system configuration information, the schedules of the broadcast contents, links to multimedia contents and streaming contents.

In one embodiment, the on-screen interactive interface includes one or more of: (a) a content selection area for the system administrator to change the current content, (b) a menu bar area configured to provide the system administrator various options to select, (c) a title area configured to display the title of the current content selected by the system administrator, and (d) a main display area configured to display information related to the current content and the specific option the system administrator selected.

In one embodiment, the location and the size of the content selection area, the menu bar area, the title area, and the main display area are setup by the system administrator through a menu option settings. The content selection area has a content display configured to display the title and logo of the current content, a content number up option and a content number down option configured to allow the system administrator to change current content.

In one embodiment, the menu bar area includes one or more of: (a) a Dashboard option to provide the system administrator an overview of the current content, (b) a Campaigns option to allow the system administrator to set up various campaigns related to the current content, (c) an applications option to allow the system administrator to set up various applications related to the current content, (d) a streams option to allow the system administrator to set up various content related to the current content, (e) a social network option to allow the system administrator to set up various social network access available to the current content, (f) an earnings option to display the system administrator the earning information related to the current content, (g) a users option to display the system administrator the statistics of user interactions, (h) a reports option configured to allow the system administrator to generate various reports related to the current content, (i) an ADS option configured to allow the system administrator to set up various advertisements related to the current content, and (j) a settings option configured to allow the system administrator to set up the system administrator's preferences.

In one embodiment, the display area of the Dashboard option includes one or more of: (a) a Schedule option configured to allow the system administrator to schedule multimedia contents, television programs and advertisement contents, (b) a social network option configured to allow the system administrator to quickly access to the social network outlets, (c) an Earnings option configured to display up to the minute earnings, (d) a Statistics option configured to display the user interactions statistics, (e) a Users option configured to display detailed information related to the users, (f) a graphical presentation of the statistics of user interactions, (g) various applications icons available for the current content, and (h) various campaigns available to the system administrator to use now or in the future.

In one embodiment, the Schedule option of the Dashboard option is configured for the system administrator to: (a) edit schedule of contents, campaigns, applications icons, (b) edit a Gantt style chart that displays all items including: campaigns, commercials, contents, advertisements, buy it now, shopping modules, notifications, polls, and (c) display user interaction statistics in line graph form to display viewer activity during time period specific streaming content. The Earnings option of the Dashboard option is configured to display: (a) the earning for a specific period of time from activities and campaigns, and indicating any new users that are added as fans, followers, and subscribers, and (b) a breakdown of the earnings by campaign, type of activity, application, content, viewer demographics, time period, period, leading advertisers, location, etc. The Statistics option of the Dashboard option is configured to display an umbrella of streams within a content provider family and bird's eye view statistics. The Users option of the Dashboard option is configured to display viewer activity across a multimedia platform and the analytics behind the interactions within the platform.

In one embodiment, the graphical presentation of the statistics of user interactions includes one or more of: a line graph, a bar graph, and a pie chart. The plurality of applications icons available for the current content is displayed in a list form, a matrix form, an abbreviated form, a horizontal icon view with a sliding bar to display a predetermined number of applications icons, in a predetermined order setup by the system administrator. The plurality of applications icons available for the current content is scheduled and activated by the system administrator through the Applications option. The system administrator can test the plurality of application icons by selecting preview option.

In one embodiment, the plurality of campaigns available to the system administrator to use is displayed in a list form, a matrix form, and an abbreviated form, in a predetermined order setup by the system administrator. The plurality of campaigns available to the system administrator to use is scheduled and activated by the system administrator through the Campaigns option. The Campaigns option allows the system administrator to manage menu items, pop ups, interactive apps, icons, notifications, polls. The system administrator can experience demo of campaign by using a “PREVIEW” option.

In one embodiment, the Applications option allows the system administrator to: (a) generate reports related to the plurality of Applications icons, (b) select a specific date to see the users interactions on the specific date, (c) select a different date to display the applications results on that specific date, (d) select various option from a pull-down menu to edit, schedule and activate applications icons, (e) display a summary of total number of applications icons are listed here and the total number of activated applications icons, and (f) display the plurality of the applications icons available. The Applications option has an Application library and the Application library contains: (a) various applications icons, (b) various shopping module applications, (c) various “Buy it Now” applications, and (d) various Polls applications.

In one embodiment, the Streams option allows the system administrator to: (a) generate various reports related to the stream selected, (b) display the current date, (c) select a different date to display the stream statistics on the specific date, (d) select “CONTENT ID” to configure the contents for the streams under such content id, (e) display the total revenue of the selected streams, and (f) a stream listing under the content ID.

In one embodiment, the social network option is configured for the system administrator to enter following information for use in campaigns: (a) News clippings, articles and content, text content, recipes, etc., (b) Press accounts (Associated Press, Reuters, etc.), (c) Social network Accounts, (d) Photo sharing Accounts, (e) Photos and interactive images including flash, gifs, and animations, (f) Videos (uploaded, linked, and embedded using embed codes), (g) Programming code, (h) RSS Feeds, and (i) Merchant Accounts and Shopping gateways for purchase/commerce authentication.

In one embodiment, the Earnings option is configured to display: (a) the earning for a specific period of time from activities and campaigns, and indicating any new users that are added as fans, followers, and subscribers, and (b) a breakdown of the earnings by campaign, type of activity, application, content, viewer demographics, time period, period, leading advertisers, location, etc.

In one embodiment, the Users option is configured to: (a) generate various reports related to users, (b) select a different date to display the users demographics on that specific date, (c) display users Demographics display, (d) display Viewing Style Display, and (e) display Statistics Display. An activity score is derived based on a variety of statistics within a piece of content and compares the user activity of the content to the user activity of all the content within the Multimedia Platform. The users Demographics display includes the one or more of following user statistics: (a) viewer's gender, (b) viewer's age group, (c) viewer's income bracket, (d) viewer's education level, (e) viewer's ethnicity group, (f) viewer's location, Region, and City, (g) what viewers like, including: the items the viewers like to buy, the most clicked ads, the most watched content, and the most used applications, (h) what viewers buy, including statistics of the most browsed shopping modules, items, products, and brands, (i) viewer's browsing and buying history, (j) viewer's viewing frequency of advertisement, (k) viewer's polling feedbacks based on viewer, location, subject, topic, and responses, (l) viewer's application usage statistics, including: Menu impressions, Menu views, Menu location, Menu type, and Icon Type such as Notifications, Buy It Now, Menus, Interactive Content Applications, (m) viewer's click through rate, including click through rate by applications, by campaigns, by interactive content apps, by icons, and by notifications, etc., (n) viewer bounce rate, including rate of viewers moving through the navigations and into external destinations, (o) viewer viewing duration of advertisements, streaming video, commercials, live stream, applications, and applets and icons, and (p) viewer interaction duration such as the length of time a viewer interacts with any portion of the multimedia platform.

In one embodiment, the Viewing Style Display has a Viewing Style pull down menu. The Viewing Style pull down menu has following options: by Period, by Source, by Content Provider, by Language, and by Affiliate. The by Period option includes some or all of: Daytime, Primetime, Nighttime, or any period as defined by the system administrator. The by Source option includes one or more of: Smartphone, Computer, Set-top-box, Interactive TV, Mobile Device (iPod), Tablet PC, and any other Multi-Function Device with a processor and internet access. The by Content Provider option includes all owners of content that has been submitted to the multimedia platform and/or media servers. The by Affiliate option includes one or more of: local station, news outlet, and media distributor.

In one embodiment, the Reports option is configured to: (a) generate various reports, (b) save various reports, and (c) export various reports. The various reports are exported in at least one of the following formats: .xls (Microsoft Excel), PDF, CSV, TSV and other data files for seamless exporting.

In one embodiment, the ADS option is configured to allow the system administrator to: (a) manage various advertisements that will be display and used through various campaign currently or in the future, (b) set up campaigns by location, (c) see ad effectiveness by screen location, (d) see ad effectiveness by duration, (e) see ad effectiveness by region, locality, and (f) view and distribute ads to specific demographics. The Ad contents, times, screen location can be tailored and fine-tuned to specific viewer demographics. The statistics of the plurality of advertisements includes some or all of: (a) Advertisers, (b) Notifications, (c) Interactive Ads, (d) Image Ads, (e) Video Ads, and (f) Streaming Ads.

In one embodiment, the Settings option is configured to allow the system administrator to: (a) manage all the account settings including merchant account, users, subscribers, dashboard display, permissions and restrictions, menu types, and more, (b) control integrations using the Multimedia API, (c) test Campaigns Options, (d) manage basic, advanced, and custom implementations, (e) manage mobile and Application implementations, and (f) manage technical support.

In an additional aspect, the present invention relates to a non-transitory storage medium having computer-executable instructions stored on it. When the computer-executable instructions are executed by a processor, the computer-executable instructions cause a computer to execute a method for a system administrator to distribute and manage multiple content feeds and supplemental content using an on-screen interactive interface. In one embodiment, the method includes one or more steps of: (a) logging into a computer communicatively coupled to a network, (b) accessing a multimedia server configured to integrate multiple content feeds and supplemental contents over the network, receive the multiple content feeds and supplemental contents from various multimedia sources, (c) managing operations and sources of the multiple content feeds and supplemental contents, and (d) providing the schedules and sources of the multiple content feeds and supplemental contents to a multimedia control platform for various viewers to manage, access, select, and display the selected contents from the multimedia server to selected end user devices.

In one embodiment, the multiple content feeds and supplemental contents may include one or more of these content sources: (a) real time broadcast contents, (b) multimedia streaming contents, (c) supplemental multimedia contents, (d) multimedia content management information, and (e) advertisement contents. The multimedia control platform includes a multimedia API configured to allow the end user devices to access the multiple content feeds and supplemental contents. In one embodiment, the multimedia control platform is embedded in an end user device. In another embodiment, the multimedia control platform is embedded in a multimedia controller.

In one embodiment, the multimedia controller includes one or more of: (a) an internet connection for receiving integrated streaming contents from the multimedia server, and (b) an output to the end user device for displaying the viewer selected contents (can be internal output to device monitor), (c) a cable input for receiving broadcast contents through various cable television providers, (d) an over-air input for receiving broadcast contents through various of direct broadcast television providers, and (e) an output to the end user device for displaying the viewer selected contents. The end user device includes at least one of: a television set and or a smart television set, a desktop and/or laptop computer, a smartphone, a tablet computer, a multi-function display device such as a monitor, or a video projector.

In one embodiment, the multimedia server includes one or more of: (a) an admin web server configured to allow the system administrator to distribute and manage the multiple content feeds and supplemental contents, and (b) a multimedia database configured to store all system configuration information, the schedules of the broadcast contents, and links to multimedia contents and streaming contents.

In one embodiment, the on-screen interactive interface includes one or more of: (a) a content selection area for the system administrator to change a current content, (b) a menu bar area configured to provide the system administrator various options to select, (c) a title area configured to display the title of the current content selected by the system administrator, and (d) a main display area configured to display information related to the current content and the specific option the system administrator selected.

In one embodiment, the location and the size of the content selection area, the menu bar area, the title area, and the main display area are setup by the system administrator through a menu option settings. The content selection area has a content display configured to display the title and logo of the current content, a content number up option and a content number down option configured to allow the system administrator to change current content.

In one embodiment, the menu bar area includes one or more of: (a) a Dashboard option to provide the system administrator an overview of the current content, (b) a Campaigns option to allow the system administrator to set up various campaigns related to the current content, (c) an applications option to allow the system administrator to set up various applications related to the current content, (d) a streams option to allow the system administrator to set up various streams related to the current content, (e) a social network option to allow the system administrator to set up various social network access available to the current content, (f) an earnings option to display the system administrator the earning information related to the current content, (g) a users option to display the system administrator the statistics of user interactions, (h) a reports option configured to allow the system administrator to generate various reports related to the current content, (i) an ADS option configured to allow the system administrator to set up various advertisements related to the current content, and (j) a settings option configured to allow the system administrator to set up the system administrator's preferences.

In one embodiment, the display area of the Dashboard option includes: (a) a Schedule option configured to allow the system administrator to schedule multimedia contents, television programs and advertisement contents, (b) a social network option configured to allow the system administrator to quickly access to the social network outlets, (c) an Earnings option configured to display up to the minute earnings, (d) a Statistics option configured to display the user interactions statistics, (e) a Users option configured to display detailed information related to the users, (f) a graphical presentation of the statistics of user interactions, (g) various applications icons available for the current content, and (h) various campaigns available to the system administrator to use now or in the future.

In one embodiment, the Schedule option of the Dashboard option is configured for the system administrator to: (a) edit schedule of contents, campaigns, applications icons, (b) edit a Gantt style chart that displays all items including: campaigns, commercials, contents, advertisements, buy it now, shopping modules, notifications, polls, and (c) display user interaction statistics in line graph form to display viewer activity during time period specific streaming content. The Earnings option of the Dashboard option is configured to display: (a) the earning for a specific period of time from activities and campaigns, and indicating any new users that are added as fans, followers, and subscribers, and (b) a breakdown of the earnings by campaign, type of activity, application, content, viewer demographics, time period, period, leading advertisers, location, etc. The Statistics option of the Dashboard option is configured to display an umbrella of content within a content provider family and bird's eye view statistics. The Users option of the Dashboard option is configured to display viewer activity across a multimedia platform and the analytics behind the interactions within the platform.

In one embodiment, the graphical presentation of the statistics of user interactions includes: a line graph, a bar graph, and a pie chart. The plurality of applications icons available for the current content is displayed in a list form, a matrix form, an abbreviated form, a horizontal icon view with a sliding bar to display a predetermined number of applications icons, in a predetermined order setup by the system administrator. The plurality of applications icons available for the current content is scheduled and activated by the system administrator through the Applications option. The system administrator can test the plurality of application icons by selecting preview option.

In one embodiment, the plurality of campaigns available to the system administrator to use is displayed in a list form, a matrix form, and an abbreviated form, in a predetermined order setup by the system administrator. The plurality of campaigns available to the system administrator to use is scheduled and activated by the system administrator through the Campaigns option. The Campaigns option allows the system administrator to manage menu items, pop ups, interactive apps, icons, notifications, polls. The system administrator can experience demo of campaign by using a “PREVIEW” option.

In one embodiment, the Applications option allows the system administrator to: (a) generate reports related to the plurality of Applications icons, (b) select a specific date to see the users interactions on the specific date, (c) select a different date to display the applications results on that specific date, (d) select various option from a pull-down menu to edit, schedule and activate applications icons, (e) display a summary of total number of applications icons are listed here and the total number of activated applications icons, and (f) display the plurality of the applications icons available. The Applications option has an Application library and the Application library contains: (a) various applications icons, (b) various shopping module applications, (c) various “Buy it Now” applications, and (d) various Polls applications.

In one embodiment, the Streams option allows the system administrator to: (a) generate various reports related to the stream selected, (b) display the current date, (c) select a different date to display the stream statistics on the specific date, (d) select “CONTENT ID” to configure the contents for the steams under such content id, (e) display the total revenue of the selected streams, and (f) a stream listing under the content ID.

In one embodiment, the social network option is configured for the system administrator to enter following information for use in campaigns: (a) News clippings, articles and content, text content, recipes, etc., (b) Press accounts (Associated Press, Reuters, etc.), (c) Social network Accounts, (d) Photo sharing Accounts, (e) Photos and interactive images including flash, gifs, and animations, (f) Videos (uploaded, linked, and embedded using embed codes), (g) Programming code, (h) RSS Feeds, and (i) Merchant Accounts and Shopping gateways for purchase/commerce authentication.

In one embodiment, the Earnings option is configured to display: (a) the earning for a specific period of time from activities and campaigns, and indicating any new users that are added as fans, followers, and subscribers, and (b) a breakdown of the earnings by campaign, type of activity, application, content, viewer demographics, time period, period, leading advertisers, location, etc.

In one embodiment, the Users option is configured to: (a) generate various reports related to users, (b) select a different date to display the users demographics on that specific date, (c) display users Demographics display, (d) display Viewing Style Display, and (e) display Statistics Display. An activity score is derived based on a variety of statistics within a piece of content and compares the user activity of the content to the user activity of all the content within the Multimedia Platform. The users Demographics display includes the following user statistics: (a) viewer's gender, (b) viewer's age group, (c) viewer's income bracket, (d) viewer's education level, (e) viewer's ethnicity group, (f) viewer's location, Region, and City, (g) what viewers like, including: the items the viewers like to buy, the most clicked ads, the most watched content, and the most used applications, (h) what viewers buy, including statistics of the most browsed shopping modules, items, products, and brands, (i) viewer's browsing and buying history, (j) viewer's viewing frequency of advertisement, (k) viewer's polling feedbacks based on viewer, location, subject, topic, and responses, (l) viewer's application usage statistics, including: Menu impressions, Menu views, Menu location, Menu type, and Icon Type such as Notifications, Buy It Now, Menus, Interactive Content Applications, (m) viewer's click through rate, including click through rate by applications, by campaigns, by interactive content apps, by icons, and by notifications, etc., (n) viewer bounce rate, including rate of viewers moving through the navigations and into external destinations, (o) viewer viewing duration of advertisements, streaming video, commercials, live stream, applications, and applets and icons, and (p) viewer interaction duration such as the length of time a viewer interacts with any portion of the multimedia platform.

In one embodiment, the Viewing Style Display has a Viewing Style pull down menu. The Viewing Style pull down menu has following options: by Period, by Source, by Content Provider, by Language, and by Affiliate. The by Period option includes: Daytime, Primetime, Nighttime, or any period as defined by the system administrator. The by Source option includes: Smartphone, Computer, Set-top-box, Interactive TV, Mobile Device (iPod), Tablet PC, and any other Multi-Function Device with a processor and internet access. The by Content Provider option includes all owners of content that has been submitted to the multimedia platform and/or media servers. The by Affiliate option includes one or more of: local station, news outlet, and media distributor.

In one embodiment, the Reports option is configured to: (a) generate various reports, (b) save various reports, and (c) export various reports. The various reports are exported in at least one of the following formats: .xls (Microsoft Excel), PDF, CSV, TSV and other data files for seamless exporting.

In one embodiment, the ADS option is configured to allow the system administrator to: (a) manage various advertisements that will be display and used through various campaign currently or in the future, (b) set up campaigns by location, (c) see ad effectiveness by screen location, (d) see ad effectiveness by duration, (e) see ad effectiveness by region, locality, and (f) view and distribute ads to specific demographics. The Ad contents, times, screen location can be tailored and fine-tuned to specific viewer demographics. The statistics of the plurality of advertisements includes: (a) Advertisers, (b) Notifications, (c) Interactive Ads, (d) Image Ads, (e) Video Ads, and (f) Streaming Ads.

In one embodiment, the Settings option is configured to allow the system administrator to: (a) manage all the account settings including merchant account, users, subscribers, dashboard display, permissions and restrictions, menu types, and more, (b) control integrations using the Multimedia API, (c) test Campaigns Options, (d) manage basic, advanced, and custom implementations, (e) manage mobile and Application implementations, and (f) manage technical support.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims, the foregoing description and the exemplary embodiments described therein, and accompanying drawings.

What is claimed is:

1. A system for a system administrator to distribute and manage multiple content feeds and supplemental content using an on-screen interactive interface, comprising:
(a) a plurality of multimedia sources configured to provide multiple content feeds and supplemental contents;
(b) a multimedia server configured to integrate multiple content feeds and supplemental contents over a network;
(c) a computer communicatively coupled to the network configured for the system administrator to manage the schedule and the source of the plurality of multimedia sources; and
(d) a multimedia control platform for a plurality of viewers to manage, access, and select the multiple content feeds and supplemental contents from the multimedia server through an on-screen interactive interface, and to display selected contents in a plurality of end user devices.

2. The system of claim 1, wherein the multiple content feeds and supplemental contents comprise one or more of following contents:
(a) real time broadcast contents;
(b) multimedia streaming contents;
(c) supplemental multimedia contents;
(d) multimedia content management information; and
(e) advertisement contents.

3. The system of claim 2, wherein the multimedia control platform comprises a multimedia API configured to allow the plurality of the end user devices to access the multiple content feeds and supplemental contents.

4. The system of claim 3, wherein the multimedia control platform is embedded in the plurality of end user devices, or a multimedia controller.

5. The system of claim 4, wherein the multimedia server comprises one or more of:
(a) an admin web server configured to allow the system administrator to distribute and manage the multiple content feeds and supplemental contents; and
(b) a multimedia database configured to store all system configuration information, the schedules of the multiple content feeds and supplemental contents, links to multimedia contents and streaming contents.

6. The system of claim 5, wherein the on-screen interactive interface comprises one or more of following areas:
(a) a content selection area for the system administrator to select current content;
(b) a menu bar area configured to provide the system administrator a plurality of options to distribute and manage multiple content feeds and supplemental content;
(c) a title area configured to display the title of the current content selected by the system administrator; and
(d) a main display area configured to display information related to the current content and the specific option the system administrator selected.

7. The system of claim 6, wherein the location and the size of the content selection area, the menu bar area, the title area, and the main display area are setup by the system administrator through a menu option settings.

8. The system of claim 7, wherein the menu bar area comprises one or more of following options:
(a) a Dashboard option to provide the system administrator an overview of the current content;
(b) a Campaigns option to allow the system administrator to set up a plurality of campaigns related to the current content;
(c) an applications option to allow the system administrator to set up a plurality of applications related to the current content;
(d) a streams option to allow the system administrator to set up a plurality of streams related to the current content;
(e) a social network option to allow the system administrator to set up various social network access available to the current content;
(f) an earnings option to display the system administrator the earning information related to the current content;
(g) a users option to display the system administrator the statistics of user interactions;
(h) a reports option configured to allow the system administrator to generate a plurality of reports related to the current content;
(i) an ADS option configured to allow the system administrator to set up a plurality of advertisements related to the current content; and
(j) a settings option configured to allow the system administrator to set up the system administrator's preferences.

9. A method for a system administrator to distribute and manage multiple content feeds and supplemental content using an on-screen interactive interface, comprising one or more of following operations:
(a) logging into a computer communicatively coupled to a network;
(b) accessing a multimedia server configured to integrate multiple content feeds and supplemental contents over the network, wherein the multiple content feeds and supplemental contents are received from a plurality of multimedia sources;
(c) managing operations and sources of the multiple content feeds and supplemental contents; and
(d) providing the schedules and sources of the multiple content feeds and supplemental contents to a multimedia control platform for a plurality of viewers to manage, access, select, and display the selected contents from the multimedia server to selected a plurality of end user devices.

10. The method of claim 9, wherein the multiple content feeds and supplemental contents comprise one or more of following contents:
(a) real time broadcast contents;
(b) multimedia streaming contents;
(c) supplemental multimedia contents;
(d) multimedia content management information; and
(e) advertisement contents.

11. The method of claim 10, wherein the multimedia control platform comprises a multimedia API configured to allow the plurality of the end user devices to access the multiple content feeds and supplemental contents.

12. The method of claim 11, wherein the multimedia control platform is embedded in the plurality of end user devices, or a multimedia controller.

13. The method of claim 12, wherein the on-screen interactive interface comprises one or more of following areas:
(a) a content selection area for the system administrator to select current content;
(b) a menu bar area configured to provide the system administrator a plurality of options to select;
(c) a title area configured to display the title of the current content selected by the system administrator; and
(d) a main display area configured to display information related to the current content and the specific option the system administrator selected.

14. The method of claim 13, wherein the menu bar area comprises one or more of following options:
(a) a Dashboard option to provide the system administrator an overview of the current content;
(b) a Campaigns option to allow the system administrator to set up a plurality of campaigns related to the current content;
(c) an applications option to allow the system administrator to set up a plurality of applications related to the current content;
(d) a streams option to allow the system administrator to set up a plurality of streams related to the current content;
(e) a social network option to allow the system administrator to set up various social network access available to the current content;
(f) an earnings option to display the system administrator the earning information related to the current content;
(g) a users option to display the system administrator the statistics of user interactions;
(h) a reports option configured to allow the system administrator to generate a plurality of reports related to the current content;
(i) an ADS option configured to allow the system administrator to set up a plurality of advertisements related to the current content; and
(j) a settings option configured to allow the system administrator to set up the system administrator's preferences.

15. A non-transitory storage medium storing computer-executable instructions which, when executed by one or more processors of a system for distributing and managing multiple content feeds and supplemental content using an on-screen interactive interface, the computer-executable instructions cause the system to perform one or more of these operations:
(a) logging into a computer communicatively coupled to a network;
(b) accessing a multimedia server configured to integrate multiple content feeds and supplemental contents over the network, wherein the multiple content feeds and supplemental contents are received from a plurality of multimedia sources;
(c) managing schedules and sources of the multiple content feeds and supplemental contents; and
(d) providing the schedules and sources of the multiple content feeds and supplemental contents to a multimedia control platform for a plurality of viewers to manage, access, select, and display the selected contents from the multimedia server to selected a plurality of end user devices.

16. The non-transitory storage medium of claim 15, wherein the multiple content feeds and supplemental contents comprise one or more of following contents:
(a) real time broadcast contents;
(b) multimedia streaming contents;
(c) supplemental multimedia contents;
(d) multimedia content management information; and
(e) advertisement contents.

17. The non-transitory storage medium of claim 16, wherein the multimedia control platform comprises a multimedia API configured to allow the plurality of the end user devices to access the multiple content feeds and supplemental contents.

18. The non-transitory storage medium of claim 17, wherein the multimedia control platform is embedded in the plurality of end user devices, or a multimedia controller.

19. The non-transitory storage medium of claim 18, wherein the on-screen interactive interface comprises one or more of following areas:
(a) a content selection area for the system administrator to select current content;
(b) a menu bar area configured to provide the system administrator a plurality of options to select;
(c) a title area configured to display the title of the current content selected by the system administrator; and
(d) a main display area configured to display information related to the current content and the specific option the system administrator selected.

20. The non-transitory storage medium of claim 19, wherein the menu bar area comprises one or more of following options:
(a) a Dashboard option to provide the system administrator an overview of the current content;
(b) a Campaigns option to allow the system administrator to set up a plurality of campaigns related to the current content;
(c) an applications option to allow the system administrator to set up a plurality of applications related to the current content;
(d) a streams option to allow the system administrator to set up a plurality of streams related to the current content;
(e) a social network option to allow the system administrator to set up various social network access available to the current content;
(f) an earnings option to display the system administrator the earning information related to the current content;
(g) a users option to display the system administrator the statistics of user interactions;
(h) a reports option configured to allow the system administrator to generate a plurality of reports related to the current content;
(i) an ADS option configured to allow the system administrator to set up a plurality of advertisements related to the current content; and
(j) a settings option configured to allow the system administrator to set up the system administrator's preferences.
